(19) United States
(12) Patent Application Publication
(10) Pub. No.: US 2018/0201094 A1
(43) Pub. Date: Jul. 19, 2018

(54) HEAT PUMP CYCLE

(71) Applicant: DENSO CORPORATION, Kariya-city, Aichi-pref. (JP)

(72) Inventors: Hiroaki KAWANO, Kariya-city (JP); Satoshi ITOH, Kariya-city (JP)

(21) Appl. No.: 15/743,331

(22) PCT Filed: Jun. 29, 2016
(86) PCT No.: PCT/JP2016/069264

§ 371 Date: Jan. 10, 2018

(30) Foreign Application Priority Data
Jul. 14, 2015 (JP) 2015-140822

(51) Int. Cl. B60H 1/00; F25B 13/00; F25B 41/06; F25B 43/00

(52) U.S. Cl. CPC B60H 1/00907; F25B 13/00; F25B 41/062; F25B 43/006; F25B 2700/21172; B60H 2001/00935; F25B 2313/02741; F25B 2313/0316; F25B 2700/21162; B60H 2001/00092

(57) ABSTRACT

A heat pump cycle includes a first usage side heat exchanger that heats a target fluid via heat exchange with refrigerant discharged from a compressor. The refrigerant flowing out of the first usage side heat exchanger is reduced in pressure by a first pressure reducing unit, and then separated into gas and liquid by a gas-liquid separation unit. The separated gas-phase refrigerant flows toward an intermediate-pressure port of the compressor. The separated liquid-phase refrigerant is reduced in pressure by a second pressure reducing unit. An additional heat exchanger performs heat exchange between the refrigerant flowing from the second pressure reducing unit and a heat medium, and allows the refrigerant to flow toward an intake port of the compressor. A second usage side heat exchanger performs heat exchange between the separated liquid-phase refrigerant and a counterpart fluid, and allows the refrigerant to flow toward the second pressure reducing unit.

### CROSS REFERENCE TO RELATED APPLICATION

This application is based on and incorporates herein by reference Japanese Patent Application No. 2015-140822 filed on Jul. 14, 2015.

### TECHNICAL FIELD

The present disclosure relates to a heat pump cycle.

### BACKGROUND ART

Patent Literature 1 discloses a technique where, in a vehicle air conditioning apparatus having a gas injection cycle, when a heating capacity does not reach a required heating capacity, the opening degree of an electric expansion valve provided on an outlet side of a heating interior heat exchanger is opened. With the above operation, a flow rate of the refrigerant flowing into an intermediate-pressure port of a compressor increases. The air conditioning apparatus increases the heating capacity by increasing a flow rate of the refrigerant flowing into an intermediate-pressure port of the compressor.

### PRIOR ART LITERATURE

### Patent Literature

Patent Literature 1: JP H09-086149 A

### SUMMARY

In the vehicle air conditioning apparatus as disclosed in Patent Literature 1, the heating capacity is proportional to an enthalpy difference (that is, heat absorption amount) between an inlet and an outlet of the exterior heat exchanger and a flow rate of the refrigerant discharged from the compressor. In the device of Patent Literature 1, a pressure of the refrigerant flowing into an intermediate-pressure port of the compressor becomes higher, and the enthalpy difference (that is, heat absorption amount) between the inlet and outlet of the exterior heat exchanger decreases. However, the flow rate of the refrigerant flowing into the intermediate-pressure port of the compressor increases, and thereby a workload of the compressor is increased and the heating capacity increases.

However, as a result of detailed examination by the inventors, it has been found out that the device of Patent Literature 1 suffers from the following problems. It is assumed that the refrigerant pressure to the intermediate-pressure port of the compressor increases and the heat absorption amount of the exterior heat exchanger decreases. At this time, if the workload of the compressor increased in association with an increase in the flow rate of the refrigerant to the intermediate-pressure port of the compressor falls below a decrement of the heat absorption amount of the exterior heat exchanger, the heating capacity in the heat pump cycle cannot be improved.

As described above, in the configuration described in Patent Literature 1, there is a problem that when the pressure of the intermediate-pressure refrigerant rises, the heating capacity in the heat pump cycle cannot be improved.

In view of the foregoing difficulties, it is an object of the present disclosure to provide a heat pump cycle capable of improving a heating capacity irrespective of a refrigerant pressure of an intermediate-pressure port of a compressor.

According to an aspect of the present disclosure, a heat pump cycle includes: a compressor that compresses a low-pressure refrigerant drawn through an intake port, discharges a high-pressure refrigerant through a discharge port, and includes an intermediate-pressure port through which an intermediate-pressure refrigerant in a cycle flows into the compressor to be mixed with refrigerant being in a process of being compressed; a first usage side heat exchanger that heats a heat exchange target fluid by performing heat exchange between the high-pressure refrigerant discharged from the discharge port and the heat exchange target fluid; a first pressure reducing unit that reduces a pressure of the high-pressure refrigerant flowing out of the first usage side heat exchanger such that the high-pressure refrigerant becomes the intermediate-pressure refrigerant; a gas-liquid separation unit that separates the refrigerant that has passed through the first pressure reducing unit into gas and liquid, and allows a separated gas-phase refrigerant to flow out toward the intermediate-pressure port; a second pressure reducing unit that reduces a pressure of a liquid-phase refrigerant separated by the gas-liquid separation unit such that the liquid-phase refrigerant becomes the low-pressure refrigerant; an additional heat exchanger that performs heat exchange between the refrigerant which has passed through the second pressure reducing unit and a heat medium, and allows the refrigerant to flow out toward the intake port; and a second usage side heat exchanger that performs heat exchange between the liquid-phase refrigerant separated by the gas-liquid separation unit and a counterpart fluid, and allows the refrigerant to flow out toward the second pressure reducing unit.

As described above, the second usage side heat exchanger subcools the liquid-phase refrigerant by performing heat exchange between the liquid-phase refrigerant separated by the gas-liquid separation unit and the counterpart fluid. This makes it possible to reduce the enthalpy of the refrigerant flowing into the additional heat exchanger regardless of the refrigerant pressure of the intermediate-pressure port of the compressor. As a result, the amount of heat absorbed by the additional heat exchanger is increased so that the amount of heat radiation of the refrigerant to the heat exchange target fluid can be increased.

### BRIEF DESCRIPTION OF THE DRAWINGS

FIG. 1 is an overall configuration diagram of a vehicle air conditioning apparatus to which a heat pump cycle is applied according to a first embodiment.

FIG. 2 is a flowchart showing a control process of an air-conditioning control device in a heat pump cycle according to the first embodiment

FIG. 3 is an overall configuration diagram showing a flow of a refrigerant in a cooling mode and a dehumidification heating mode of the heat pump cycle according to the first embodiment.

FIG. 4 is an overall configuration diagram showing a flow of the refrigerant in a heating mode of the heat pump cycle according to the first embodiment.

FIG. 5 is a Mollier diagram showing a state of the refrigerant in the heating mode of the heat pump cycle according to the first embodiment.

FIG. 6 is an overall configuration diagram showing a flow of a refrigerant in the case where an outside air temperature is lower than a temperature of a liquid-phase refrigerant flowing out from a gas-liquid separator in a heat pump cycle according to a second embodiment.

FIG. 7 is a flowchart of a flow channel switching control by an air-conditioning control device of the heat pump cycle according to the second embodiment.

FIG. 8 is an overall configuration diagram showing a flow of the refrigerant in the case where an outside air temperature is equal to or higher than a temperature of a liquid-phase refrigerant flowing out from a gas-liquid separator in a heat pump cycle according to the second embodiment.

FIG. 9 is an overall configuration diagram showing a flow of a refrigerant in a heating mode of a heat pump cycle according to a third embodiment.

FIG. 10 is an overall configuration diagram showing the flow of the refrigerant in a cooling mode of the heat pump cycle according to the third embodiment.

FIG. 11 is an overall configuration diagram showing a flow of a refrigerant in a heating mode of a heat pump cycle according to a fourth embodiment.

FIG. 12 is an overall configuration diagram showing a flow of a refrigerant in a heating mode of a heat pump cycle according to a fifth embodiment.

FIG. 13 is an overall configuration diagram showing a flow of a refrigerant in a heating mode of a heat pump cycle according to a sixth embodiment.

FIG. 14 is an overall configuration diagram showing a flow of a refrigerant in a heating mode of a heat pump cycle according to a seventh embodiment.

FIG. 15 is an overall configuration diagram showing a flow of a refrigerant in a heating mode of a heat pump cycle according to an eighth embodiment.

### DESCRIPTION OF EMBODIMENTS

Hereinafter, multiple embodiments for implementing the present disclosure will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

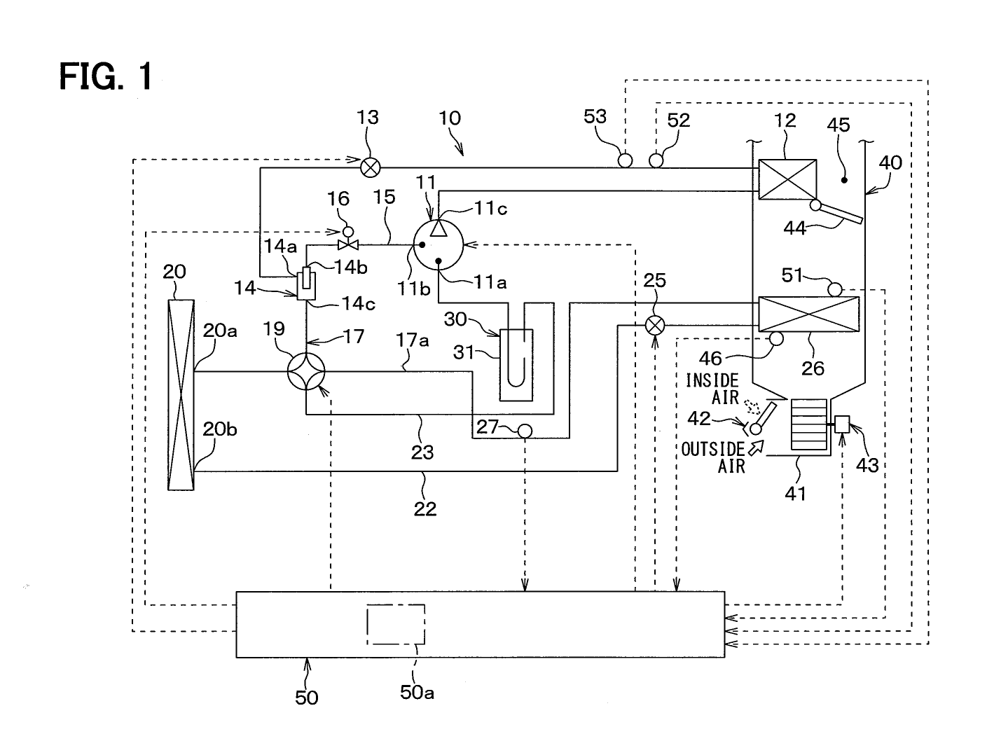

Next, a first embodiment will be described. In the present embodiment, as shown in FIG. 1, a heat pump cycle 10 is applied to a vehicle air conditioning apparatus 1 for an electric vehicle or a hybrid vehicle which obtains a vehicle travel driving force from a traveling electric motor.

In the heat pump cycle 10, a blown air to be blown into a vehicle interior, which is an air-conditioning target space, indicates a heat exchange target fluid and a counterpart fluid in a vehicle air conditioning apparatus. The heat pump cycle 10 according to the present embodiment is configured to be switchable to a cooling mode in which a vehicle interior is cooled by cooling the blown air, a dehumidification heating mode in which the vehicle interior is dehumidified and heated by heating the blown air that has been cooled, and a heating mode in which the vehicle interior is heated by heating the blown air.

The heat pump cycle 10 according to the present embodiment employs an HFC based refrigerant (for example, R134a) as the refrigerant, and configures a subcritical refrigeration cycle of a vapor compression type in which a refrigerant pressure on the high-pressure side in the cycle does not exceed a critical pressure of the refrigerant. It is needless to say that an HFO based refrigerant (for example, R1234yf) may be employed as the refrigerant.

A lubricant (that is, refrigerator oil) for lubricating various components inside a compressor 11 is mixed in the refrigerant of the heat pump cycle 10. Part of the lubricant circulates through a cycle together with the refrigerant.

The compressor 11, which is a component device of the heat pump cycle 10, is disposed in an engine compartment of the vehicle. In the heat pump cycle 10, the compressor 11 functions to take in the refrigerant, and compress and discharge the refrigerant.

The compressor 11 is a two-stage boost compressor in which a low stage side compression unit and a high stage side compression unit, each of which is a fixed capacity type compression mechanism, are housed inside a housing forming an outer shell. Various types of compression mechanisms such as a scroll-type, a vane-type, or a rolling piston-type can be employed for each compression unit.

The compressor 11 of the present embodiment configures an electric compressor in which each compression unit is rotationally driven by an electric motor. The operation (that is, rotational speed) of the electric motor of the compressor 11 is controlled by a control signal that is output from an air-conditioning control device 50 to be described below. In the compressor 11, a refrigerant discharge capacity can be changed by controlling the rotational speed of the electric motor.

The housing of the compressor 11 is provided with an intake port 11a, an intermediate-pressure port 11b, and a discharge port 11c. The intake port 11a is a port for taking in the low-pressure refrigerant from the outside of the housing into the low stage side compression unit. The discharge port 11c is a port for discharging the high-pressure refrigerant discharged from the high stage side compression unit to the outside of the housing.

The intermediate-pressure port 11b is a port for introducing a gas-phase refrigerant having an intermediate pressure which flows in the cycle from the outside of the housing to merge with the refrigerant subjected to a compression process. Specifically, the intermediate-pressure port 11b is connected between a refrigerant outlet of a low stage side compression unit and a refrigerant inlet of a high stage side compression unit.

A refrigerant inlet side of an interior condenser 12 is connected to the discharge port 11c of the compressor 11. The interior condenser 12 is disposed in an air conditioning case 41 of an interior air conditioning unit 40 to be described later. The interior condenser 12 is a first usage side heat exchanger that performs heat exchange between the high-pressure refrigerant discharged from the discharge port 11c of the compressor 11 and the heat exchange target fluid (that is, blown air), and heats the heat exchange target fluid.

A refrigerant outlet side of the interior condenser 12 is connected with a first pressure reducing mechanism 13 that reduces the pressure of the high-pressure refrigerant flowing out from the interior condenser 12 down to the intermediate-pressure refrigerant. The first pressure reducing mechanism 13 includes a valve body configured to be changeable in a throttle opening degree, and an actuator that drives the valve body.

The first pressure reducing mechanism 13 according to the present embodiment is configured by a variable throttle mechanism that can be set to a throttling state that exhibits a pressure reducing action and a fully opened state that does not exhibit the pressure reducing action. The first pressure reducing mechanism 13 is configured by an electric variable throttle mechanism which is controlled by a control signal output from the air-conditioning control device 50. The first pressure reducing mechanism 13 is a first pressure reducing unit that reduces the pressure of the high-pressure refrigerant flowing out from the interior condenser 12 down to an intermediate-pressure refrigerant.

A gas-liquid separator 14 is connected to an outlet side of the first pressure reducing mechanism 13. The gas-liquid separator 14 is a gas-liquid separation unit that separates the gas-liquid of the refrigerant that has passed through the first pressure reducing mechanism 13 and allows the separated gas-phase refrigerant to flow out to the intermediate-pressure port 11b of the compressor 11. The gas-liquid separator 14 according to the present embodiment is a centrifugal-type gas-liquid separator that separates the gas-liquid of the refrigerant by the aid of the action of a centrifugal force.

The gas-liquid separator 14 is provided with an inflow port 14a which is an inflow port into which the refrigerant flows, a gas phase port 14b which is an outflow port of the gas-phase refrigerant separated inside, and a liquid phase port 14c that is an outflow port of the liquid-phase refrigerant separated inside.

An intermediate-pressure refrigerant passage 15 is connected to the gas phase port 14b of the gas-liquid separator 14. The intermediate-pressure refrigerant passage 15 is a refrigerant passage that leads the gas-phase refrigerant to the intermediate-pressure port 11b of the compressor 11 and merges the gas-phase refrigerant with the refrigerant subjected to the compression process in the compressor 11.

An intermediate opening and closing mechanism 16 is disposed as a passage opening and closing mechanism for opening and closing the intermediate-pressure refrigerant passage 15 in the intermediate-pressure refrigerant passage 15. The intermediate opening and closing mechanism 16 is configured by an electromagnetic valve that is controlled by a control signal outputted from the air-conditioning control device 50. The intermediate opening and closing mechanism 16 functions as a flow channel switching unit that opens and closes the intermediate-pressure refrigerant passage 15, to thereby switch the refrigerant flow channel in the cycle to another.

A liquid-phase refrigerant passage 17 is connected to the liquid phase port 14c of the gas-liquid separator 14. The liquid-phase refrigerant passage 17 is a refrigerant passage that leads the liquid-phase refrigerant separated by the gas-liquid separator 14 to a four-way valve 19 to be described later.

The four-way valve 19 according to the present embodiment is configured by, for example, an electric type flow channel switching valve including a rotary valve body and an electric actuator for displacing the valve body. The operation of the four-way valve 19 is controlled according to a control signal output from the air-conditioning control device 50 to be described later.

The four-way valve 19 is a refrigerant flow channel switching unit that switches between a refrigerant flow path of the heat pump cycle 10 during a vehicle interior cooling and a refrigerant flow channel of the heat pump cycle 10 during a vehicle interior heating.

Specifically, during the vehicle interior cooling, the four-way valve 19 connects the liquid-phase refrigerant outlet side of the gas-liquid separator 14 to a refrigerant inlet and outlet 20a of the exterior heat exchanger 20, which will be described later, and connects the refrigerant outlet side of the interior evaporator 26, which will be described later, to a refrigerant inlet side of an accumulator 30 which will be described later. As a result, the refrigerant discharged from the compressor 11 passes through the interior condenser 12, the first pressure reducing mechanism 13, the gas-liquid separator 14, the four-way valve 19, the exterior heat exchanger 20, the second pressure reducing mechanism 25, the interior evaporator 26, the four-way valve 19, and the accumulator 30 in the stated order, and is again drawn into the compressor 11.

Specifically, during the vehicle interior heating, the four-way valve 19 connects the liquid-phase refrigerant outlet side of the gas-liquid separator 14 to the interior evaporator 26, and connects the refrigerant inlet and outlet 20a of the exterior heat exchanger 20, which will be described later, to a refrigerant inlet side of the accumulator 30 which will be described later. As a result, the refrigerant discharged from the compressor 11 passes through the interior condenser 12, the first pressure reducing mechanism 13, the gas-liquid separator 14, the four-way valve 19, the interior evaporator 26, the second pressure reducing mechanism 25, the exterior heat exchanger 20, the four-way valve 19, and the accumulator 30 in the stated order, and is again drawn into the compressor 11.

An exterior heat exchanger 20 is connected to the four-way valve 19.

The exterior heat exchanger 20 is a heat exchanger which is disposed in an engine compartment and performs heat exchange between the liquid-phase refrigerant separated by the gas-liquid separator 14 and the outside air (that is, vehicle exterior air). The exterior heat exchanger 20 corresponds to an additional heat exchanger.

The exterior heat exchanger 20 has a pair of refrigerant inlet and outlet ports 20a and 20b. The refrigerant inlet and outlet 20a of the exterior heat exchanger 20 is connected to the four-way valve 19. The exterior heat exchanger 20 functions as a heat-absorbing heat exchanger that evaporates the low-pressure refrigerant and exerts a heat absorbing action in the heating mode. In addition, the exterior heat exchanger 20 functions as a radiation heat exchanger that releases the high-pressure refrigerant at least in the cooling mode.

A low-pressure refrigerant passage 22 is connected to the refrigerant inlet and outlet 20b of the exterior heat exchanger 20. The low-pressure refrigerant passage 22 is a refrigerant passage that connects the refrigerant inlet and outlet 20b of the exterior heat exchanger 20 and the second pressure reducing mechanism 25.

The second pressure reducing mechanism 25 is configured by a variable throttle mechanism that can be set to a throttling state that exhibits a pressure reducing action and a fully opened state that does not exhibit the pressure reducing action. The second pressure reducing mechanism 25 is configured by an electromagnetic valve that is controlled by a control signal outputted from the air-conditioning control device 50. The second pressure reducing mechanism according to the present embodiment corresponds to a second pressure reducing unit.

The second pressure reducing mechanism 25 functions as a pressure reducing mechanism for reducing the pressure of the refrigerant that has flowed out from the exterior heat exchanger 20 down to a low-pressure refrigerant in the cooling mode or the dehumidification heating mode. The second pressure reducing mechanism 25 according to the present embodiment also functions as a pressure reducing mechanism for reducing the pressure of the refrigerant that has flowed out from the interior evaporator 26 down to the low-pressure refrigerant in the heating mode.

The interior evaporator 26 is disposed in the air flow upstream side of the interior condenser 12 in the air conditioning case 41 of the interior air conditioning unit 40 which will be described later. The interior evaporator 26 is an evaporator that performs heat exchange between the low-pressure refrigerant which has passed through the second pressure reducing mechanism 25 and the blown air and evaporates the low-pressure refrigerant, to thereby cool the blown air. The blown air represents the heat exchange target fluid as well as the counterpart fluid. The interior evaporator 26 corresponds to an interior heat exchanger.

An inlet side of the accumulator 30 is connected to the refrigerant outflow port side of the interior evaporator 26 through a refrigerant pipe 17a and the four-way valve 19. A refrigerant temperature sensor 27 for detecting the temperature of the refrigerant flowing inside of the refrigerant pipe 17a is provided in the refrigerant pipe 17a. The refrigerant temperature sensor 27 outputs a signal indicating the temperature of the refrigerant flowing inside of the refrigerant pipe 17a to the air-conditioning control device 50.

The accumulator 30 separates the gas-liquid of the refrigerant that has flowed into the accumulator 30, and causes the separated gas-phase refrigerant and a lubricant contained in the refrigerant to flow out to the intake port 11a side of the compressor 11.

A low-pressure refrigerant passage 23 is provided between the four-way valve 19 and the accumulator 30. The low-pressure refrigerant passage 23 is a refrigerant passage that leads the refrigerant to the accumulator 30, which will be described later, while bypassing the exterior heat exchanger 20, the second pressure reducing mechanism 25, and the interior evaporator 26. An inlet side of the accumulator 30 is connected to a refrigerant outflow port side of the low-pressure refrigerant passage 23.

Subsequently, the interior air conditioning unit 40 will be described. The interior air conditioning unit 40 is disposed inside of a dashboard panel (instrument panel) on a foremost portion of the vehicle interior. The interior air conditioning unit 40 has an air conditioning case 41 that forms an outer shell of the interior air conditioning unit 40 and forms an air passage for blowing the blown air into the vehicle interior.

An inside/outside air switching device 42 configured to switch the vehicle interior air (inside air) and outside air is disposed on a most upstream side of the air conditioning case 41 along the air flow.

The inside/outside air switching device 42 adjusts opening areas of an inside air introduction port and an outside air introduction port with an inside/outside air switching door to change an air volume ratio between an inside air volume into the air conditioning case 41 and the outside air volume.

A blower 43 that blows the air introduced from the inside/outside air switching device 42 toward the vehicle interior is disposed on the air flow downstream side of the inside/outside air switching device 42. The blower 43 is an electric blower that drives a centrifugal fan such as a sirocco fan by an electric motor. A rotation speed of the blower 43 is controlled according to a control voltage output from the air-conditioning control device 50, as a result of which a blowing rate of the blower 43 is controlled.

The interior evaporator 26 and the interior condenser 12 described above are disposed on the air flow downstream side of the blower 43 along the air flow in the stated order of the interior evaporator 26 and the interior condenser 12 along the flow of the blown air. In other words, the interior evaporator 26 is disposed on the air flow upstream side of the interior condenser 12.

A cold air bypass passage 45 that bypasses the interior condenser 12 and causes the blown air that has passed through the interior evaporator 26 to flow in the cold air bypass passage 45 is provided in the air conditioning case 41. An air mixing door 44 is disposed in the air conditioning case 41 on the air flow downstream side of the interior evaporator 26 and on the air flow upstream side of the interior condenser 12.

The air mixing door 44 functions as a capacity adjustment unit that adjusts an air volume ratio between an air volume passing through the interior condenser 12 and an air volume passing through the cold air bypass passage 45 in the blown air that has passed through the interior evaporator 26 to adjust a heat exchange capability of the interior condenser 12. The air mixing door 44 is driven by an actuator not shown whose operation is controlled according to a control signal output from the air-conditioning control device 50.

In addition, a merging space not shown for merging a hot air that has passed through the interior condenser 12 with a cold air that has passed through the cold air bypass passage 45 is provided on the air flow downstream side of the interior condenser 12 and the cold air bypass passage 45.

Multiple opening holes for blowing out the blown air merged in the merging space into the vehicle interior are provided in a most downstream portion of the air flow in the air conditioning case 41. Although not shown, the air conditioning case 41 is provided with a defroster opening hole for blowing the air toward an inner surface of the window glass on the front of the vehicle, a face opening hole for blowing the conditioned air toward an upper body of the occupant in the vehicle interior, and a foot opening hole for blowing the air conditioning wind toward the feet of the occupant, as opening holes.

A defroster door, a face door, and a foot door are disposed on the air flow upstream sides of the defroster opening hole, the face opening hole, and the foot opening hole, respectively, as blowing mode doors for adjusting the opening areas of the respective opening holes. Those blowing mode doors are driven by an actuator whose operation is controlled by a control signal output from the air-conditioning control device 50 through a link mechanism not shown or the like.

Further, the air flow downstream sides of the defroster opening holes, the face opening holes, and the foot opening holes are connected to face blowing ports, foot blowing ports, and defroster blowing ports, which are provided in the vehicle interior, through ducts that form the air passages, respectively.

Next, an electric control unit according to the present embodiment will be described. The air-conditioning control device 50 includes a well-known microcomputer that includes a CPU, and memories such as a ROM and a RAM, and peripheral circuits of the microcomputer. The memory is a non- transitory tangible storage medium. The air-conditioning control device 50 corresponds to a flow channel control unit. The air-conditioning control device 50 performs various types of calculation processes on the basis of a control program stored in the memory, and controls the operation of various air conditioning controlled equipment connected to the output side of the air-conditioning control device 50.

An air conditioning control sensor group is connected to an input side of the air-conditioning control device 50. Specifically, a temperature sensor 46 that detects the temperature of the air flowing into the interior evaporator 26 (that is, the heat exchange target fluid and the counterpart fluid) is connected to the air-conditioning control device 50. The temperature sensor 46 detects an inside air temperature flowing into the interior evaporator 26 in an inside air mode, detects an outside air temperature flowing into the interior evaporator 26 in an outside air mode, and outputs a signal indicating the temperature of the detected air to the air-conditioning control device 50. The temperature sensor 46 is a temperature detection unit that detects the temperature of the air flowing into the interior evaporator 26 (that is, the heat exchange target fluid and the counterpart fluid). The air-conditioning control device 50 is connected with an outside air sensor for detecting the outside air temperature, an inside air sensor for detecting the inside air temperature, an insolation sensor for detecting the amount of insolation into the vehicle interior, and the like. None of the outside air sensor, the inside air sensor, and the insolation sensor is illustrated.

The air-conditioning control device 50 is connected with a first temperature sensor 51 that detects the temperature of the interior evaporator 26, a second temperature sensor 52 and a pressure sensor 53 which detect a temperature and a pressure of the refrigerant that has passed through the interior condenser 12, respectively, and so on, as sensors for detecting the operation states of the heat pump cycle 10. As the first temperature sensor 51, a sensor for detecting the temperature of heat exchange fins of the interior evaporator 26, a sensor for detecting the temperature of the refrigerant flowing through the interior evaporator 26, and the like can be considered, but whichever sensor may be used.

Furthermore, an operation panel on which various air conditioning operation switches are arranged is connected to the air-conditioning control device 50. Operation signals from various air conditioning operation switches of the operation panel are input to the air-conditioning control device 50. As the various air conditioning operation switches, an operation switch of the vehicle air conditioning apparatus, a temperature setting switch for setting a target temperature in the vehicle interior, an A/C switch for setting whether the blown air is cooled by the interior evaporator 26, or not, and the like are provided on the operation panel.

The air-conditioning control device 50 according to the present embodiment is a device that consolidates control units that control the operation of various controlled devices connected to the output side. Each of the control units to be consolidated may be hardware or software. The control units that are consolidated in the air-conditioning control device 50 include a driving mode switching unit 50a that switches the driving mode of the heat pump cycle 10, a discharge capacity control unit that controls the operation of the electric motor of the compressor 11, and the like. The driving mode switching unit 50a controls the four-way valve 19 to switch between the cooling mode for cooling the vehicle interior, the heating mode for heating the vehicle interior, and the dehumidification heating mode for heating the vehicle interior while dehumidifying the vehicle interior.

Subsequently, the operation of the vehicle air conditioning apparatus configured as described above will be described. In the vehicle air conditioning apparatus of the present embodiment, as described above, the mode can be switched among the cooling mode for cooling the vehicle interior, the heating mode for heating the vehicle interior, and a dehumidification heating mode for heating and dehumidifying the vehicle interior. Each of those driving modes can be switched to another mode by an air conditioning control process to be executed by the air-conditioning control device 50.

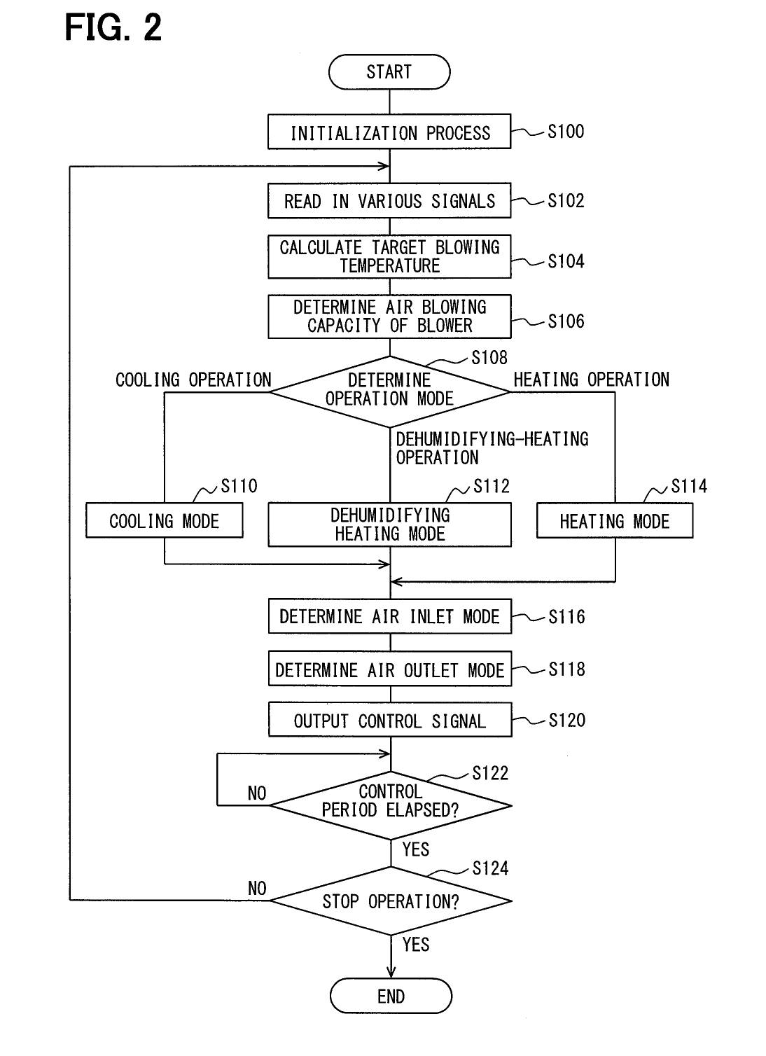

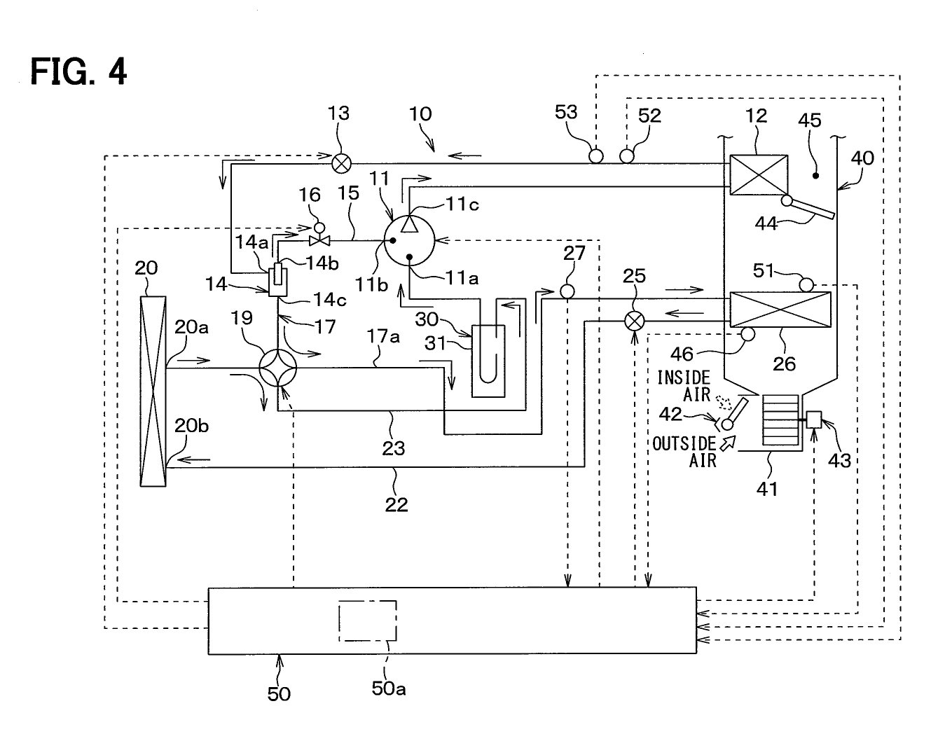

The air conditioning control process for switching the driving mode to another will be described with reference to a flowchart shown in FIG. 2. The air conditioning control process is started by turning on the operation switch of the vehicle air conditioning apparatus on the operation panel. Each step in a flowchart shown in FIG. 4 is realized by the air-conditioning control device 50, and each function realized in each step can be interpreted as a function realization unit.

When the operation switch of the vehicle air conditioning apparatus is turned on, initialization processing for initializing flags, timers, and the like stored in a memory and matching initial positions of various controlled equipment is performed (S100). In the initialization processing, values to be initialized may be adjusted to values stored in the memory at the time of stopping the operation of the vehicle air conditioning apparatus at the last time.

Subsequently, operation signals of the operation panel and detection signals of the air conditioning control sensor group are read (S102). A target blowing temperature TAO of the blown air blown into the vehicle interior is calculated on the basis of the various signals read in the processing of Step S102 (S104).

More specifically, in a calculation process of Step S104, the target blowing temperature TAO is calculated through the following Formula F1.

TAO=Kset×Tset−Kr×Tr−Kam×Tam−Ks×As+C (F1)

In this example, Tset is a target temperature in the vehicle interior set by the temperature setting switch, Tr is a detection signal detected by the inside air sensor, Tam is a detection signal detected by the outside air sensor, and As is a detection signal detected by the insolation sensor. Kset, Kr, Kam, and Ks denote control gains, and C denotes a constant for correction.

Subsequently, a blowing capability of the blower 43 is determined (S106). In a process of Step S106, an air blowing capability of the blower 43 is determined with reference to a control map stored in the memory in advance based on the target blowing temperature TAO calculated in Step S104. The air-conditioning control device 50 according to the present embodiment determines the blowing capability to be in the vicinity of a maximum capability so that the blowing rate of the blower 43 increases when the target blowing temperature TAO falls within a cryogenic range and an extremely high temperature range. Further, the air-conditioning control device 50 according to the present embodiment determines the blowing capacity to be lower than the vicinity of the maximum capacity so that the blowing rate of the blower 43 decreases when the target blowing temperature TAO increases from the cryogenic range to an intermediate temperature range or decreases from the extremely high temperature range to the intermediate temperature range.

Subsequently, the driving mode of the heat pump cycle 10 is determined based on the various signals read in Step S102 and the target blowing temperature TAO calculated in Step S104 (S108 to S114).

In a process of Step S108, when an A/C switch is turned on and the target blowing temperature TAO is lower than a predetermined cooling reference value, the cooling mode is selected to perform the cooling operation (S110). In addition, in a process of Step S108, when the A/C switch is turned on and the target blowing temperature TAO is equal to or higher than the cooling reference value, the dehumidification heating mode is selected to perform the dehumidifying heating operation (S112). Further, in a process of Step S108, when the A/C switch is turned off and the target blowing temperature TAO is equal to or higher than the heating reference value, the heating mode is selected to perform the heating operation (S114). In processes of Steps S110 to S114, control processes corresponding to the respective driving modes are executed. Details of the processes in Steps S110 to S114 will be described later.

Subsequently, a suction port mode indicating a switching state of the inside/outside air switching device 42 is determined (S116). In a process of Step S116, the suction port mode is determined with reference to the control map stored in the memory in advance based on the target blowing temperature TAO. Basically, the air-conditioning control device 50 according to the present embodiment determines the outside air mode for introducing the outside air as the suction port mode. The air-conditioning control device 50 according to the present embodiment determines, as the suction port mode, the inside air mode for introducing the inside air in a situation in which the target blowing air temperature TAO falls within the cryogenic range and a high cooling performance is required, a situation in which the target blowing temperature TAO falls within the extremely high temperature range and a high heating performance is required, and so on.

Subsequently, the air-conditioning control device 50 determines a blowing port mode (S118). In a process of Step S118, the air-conditioning control device 50 determines the blowing port mode based on the target blowing temperature TAO with reference to the control map stored in the memory in advance. The air-conditioning control device 50 according to the present embodiment determines the blowing port mode so as to shift to a foot mode, a bi-level mode, and a face mode in the stated order as the target blowing temperature TAO decreases from the high temperature range to the low temperature range.

Subsequently, the air-conditioning control device 50 outputs the control signals to the various controlled equipment connected to the air-conditioning control device 50 so as to obtain a control state determined in Steps S106 to S118 described above (S120). The air-conditioning control device 50 waits until a control cycle stored in the memory in advance has elapsed (S122).

When it is determined that the control cycle has elapsed in the process of Step S122, the air-conditioning control device 50 determines whether to stop the operation of the heat pump cycle 10 of the vehicle air conditioning apparatus, or not

(S124). In the determination process of Step S124, the air-conditioning control device 50 determines whether to receive a command signal instructing the operation stop of the heat pump cycle 10 of the vehicle air conditioning apparatus from the operation panel, the main control device, or the like, or not. If it is determined that the operation is stopped in the determination process of Step S124, the air-conditioning control device 50 executes a predetermined operation termination process. On the other hand, if it is determined in the determination process in Step S124 that the operation is not stopped, the process returns to Step S102.

Next, the processing contents of the cooling mode to be executed in Step S110, the processing contents of the dehumidification heating mode to be executed in Step S112, and the processing contents of the heating mode to be executed in Step S114 will be described.

### (a) Cooling Mode

In the present embodiment, the cooling mode configures a second driving mode in which the cooling mode functions as a heat radiation heat exchanger for radiating the exterior heat exchanger 20 to the outside air, and cools the blown air by the interior evaporator 26. The cooling mode according to the present embodiment is realized by causing the air-conditioning control device 50 to control the pressure reducing mechanisms 13, 25, the intermediate opening and closing mechanism 16, and the four-way valve 19.

More specifically, in the cooling mode, the air-conditioning control device 50 sets the first pressure reducing mechanism 13 to be in a fully opened state and sets the second pressure reducing mechanism 25 to be in a throttling state.

In addition, the air-conditioning control device 50 closes the intermediate opening and closing mechanism 16, and controls the four-way valve 19 so that the liquid-phase refrigerant outlet side of the gas-liquid separator 14 is connected to the refrigerant inlet and outlet 20a of the exterior heat exchanger 20, and the refrigerant outlet side of the interior evaporator 26 is connected to the refrigerant inlet side of the accumulator 30.

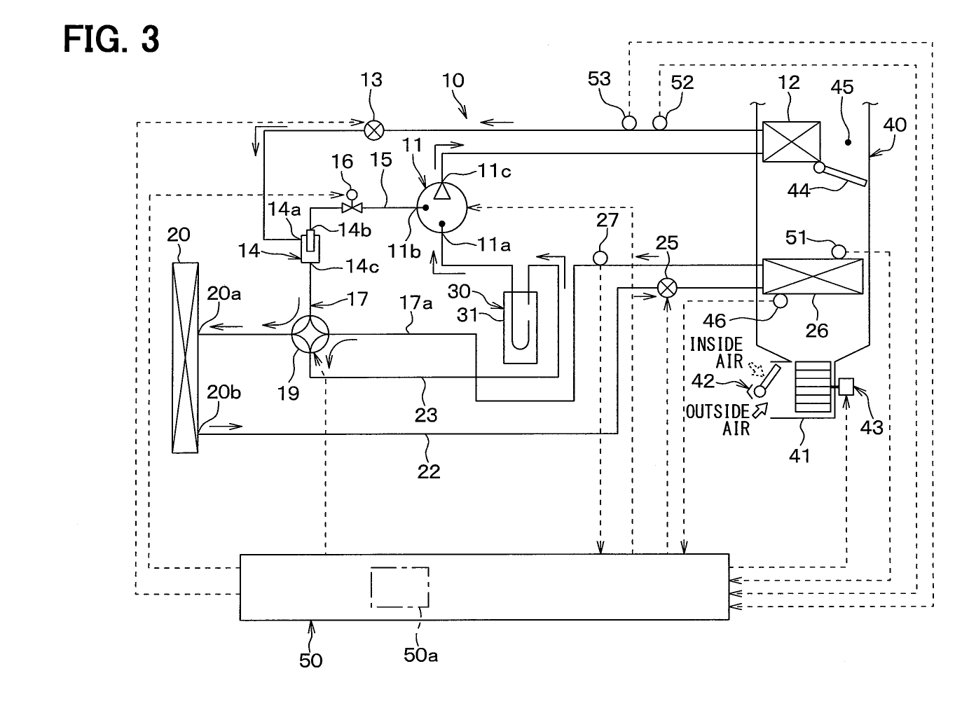

As a result, in the heat pump cycle 10 of the cooling mode, the refrigerant flows as indicated by arrows in FIG. 3. As a result, the discharged refrigerant discharged from the compressor 11 passes through the interior condenser 12, the first pressure reducing mechanism 13, the gas-liquid separator 14, the four-way valve 19, the exterior heat exchanger 20, the low-pressure refrigerant passage 22, the second pressure reducing mechanism 25, the interior evaporator 26, the accumulator 30, and the compressor 11 in the stated order.

In the cycle configuration described above, the operation state of each component of the heat pump cycle 10 is determined based on the target blowing temperature TAO calculated in step S104 and detection signals of various types of sensor groups.

For example, a control signal of the rotation speed to be output to the electric motor of the compressor 11 is determined in the following manner. First, the air-conditioning control device 50 determines a target evaporator temperature TEO of the interior evaporator 26 on the basis of the target blowing temperature TAO with reference to a control map that is stored in the memory in advance. The target evaporator temperature TEO is determined so as to be equal to or higher than a temperature (for example, 1° C.) higher than a frost forming temperature (for example, 0° C.) in order to prevent the frost formation of the interior evaporator 26.

The rotation speed of the compressor 11 is determined so that a temperature Te of the interior evaporator 26 approaches the target evaporator temperature TEO based on a deviation between the target evaporator temperature TEO and the temperature Te of the interior evaporator 26 detected by the first temperature sensor 51. The control signal corresponding to the rotation speed is output.

The control signal output to the second pressure reducing mechanism 25 is determined such that the degree of subcooling of the refrigerant flowing into the second pressure reducing mechanism 25 approaches a target degree of subcooling. The target degree of subcooling is determined so as to substantially maximize the coefficient of performance (COP) of the cycle with reference to the control map stored in the memory in advance, based on a temperature Tco and a pressure Pd of the high-pressure refrigerant that has passed through the interior condenser 12 detected by the second temperature sensor 52 and the pressure sensor 53.

Moreover, a control signal to be output to the actuator for driving the air mixing door 44 is determined so that the air mixing door 44 closes the air passage on the interior condenser 12 side, and all of the blown air that has passed through the interior evaporator 26 passes through the cold air bypass passage 45 side. In the cooling mode, the degree of opening of the air mixing door 44 may be controlled so that the blowing air temperature from the interior air conditioning unit 40 approaches the target blowing temperature TAO. The control signals and the like determined as described above are output from the air-conditioning control device 50 to various control devices.

Therefore, in the heat pump cycle 10 of the cooling mode, the high-pressure refrigerant discharged from the discharge port 11c of the compressor 11 flows into the interior condenser 12. At this time, since the air mixing door 44 closes the air passage of the interior condenser 12, almost all of the refrigerant flowing into the interior condenser 12 flows out from the interior condenser 12 without radiating a heat to the blown air.

Since the first pressure reducing mechanism 13 is in the fully opened state, the refrigerant that has flowed out from the interior condenser 12 flows into the gas-liquid separator 14 without being almost reduced in pressure by the first pressure reducing mechanism 13. In that situation, since the refrigerant hardly radiates the heat to the blown air in the interior condenser 12, the refrigerant flowing into the gas-liquid separator 14 is put in a gas-phase state. For that reason, the gas-phase refrigerant flows out into the liquid-phase refrigerant passage 17 without separating the refrigerant into gas-liquid in the gas-liquid separator 14. Further, since the intermediate opening and closing mechanism 16 is closed, no refrigerant flows into the intermediate-pressure refrigerant passage 15.

The gas-phase refrigerant that has flowed into the liquid-phase refrigerant passage 17 flows into the exterior heat exchanger 20 through the four-way valve 19. The refrigerant that has flowed into the exterior heat exchanger 20 exchanges heat with the outside air to radiate the heat and is cooled down to the target degree of subcooling.

The refrigerant that has flowed out from the exterior heat exchanger 20 flows into the second pressure reducing mechanism 25 through the low-pressure refrigerant passage 22. At this time, since the second pressure reducing mechanism 25 is in the throttling state, the refrigerant that has flowed into the second pressure reducing mechanism 25 through the low-pressure refrigerant passage 22 is reduced down to the low-pressure refrigerant. The low-pressure refrigerant that has flowed out from the second pressure reducing mechanism 25 flows into the interior evaporator 26 and evaporates by absorbing heat from the blown air that has been blown from the blower 43. As a result, the blown air is cooled and dehumidified.

The refrigerant that has flowed out from the interior evaporator 26 flows into the accumulator 30 through the four-way valve 19 and is separated into gas and liquid. The gas-phase refrigerant separated by the accumulator 30 is drawn from the intake port 11a of the compressor 11 and compressed by the low stage side compression unit and the high stage side compression unit.

As described above, in the cooling mode, the heat pump cycle 10 that causes the refrigerant to radiate the heat in the exterior heat exchanger 20 and evaporates the refrigerant in the interior evaporator 26 is configured. For that reason, since the blown air cooled by the interior evaporator 26 can be blown into the vehicle interior, the cooling in the vehicle interior can be realized. In the cooling mode, since the intermediate opening and closing mechanism 16 is closed, the compressor 11 functions as a single-stage booster type compressor.

### (b) Dehumidification Heating Mode

The dehumidification heating mode of the present embodiment configures a second driving mode in which the exterior heat exchanger 20 functions as a radiation heat exchanger that radiates the heat to the outside air, and the blown air is cooled by the interior evaporator 26. The dehumidification heating mode according to the present embodiment is realized by controlling the pressure reducing mechanisms 13, 25, the intermediate opening and closing mechanism 16, and the four-way valve 19 with the air-conditioning control device 50.

Specifically, in the dehumidification heating mode, the air-conditioning control device 50 controls the first and second pressure reducing mechanisms 13 and 25, the intermediate opening and closing mechanism 16, and the four-way valve 19 so as to provide the same refrigerant circuit as the refrigerant circuit in the cooling mode. As a result, in the heat pump cycle 10 in the dehumidification heating mode, the refrigerant flows as indicated by arrows in FIG. 3.

In the cycle configuration described above, the operation state of each component of the heat pump cycle 10 is determined based on the target blowing temperature TAO calculated in step S104 and detection signals of various types of sensor groups. For example, the control signal (rotation speed) to be output to the electric motor of the compressor 11 and the control signal to be output to the second pressure reducing mechanism 25 are determined in the same manner as that of the cooling mode.

Moreover, the control signal to be output to the actuator for driving the air mixing door 44 is determined so that the air mixing door 44 closes the cold air bypass passage 45, and a total flow rate of the blown air that has passed through the interior evaporator 26 passes through the interior condenser 12. In the dehumidification heating mode, the degree of opening of the air mixing door 44 may be controlled so that the blowing air temperature from the interior air conditioning unit 40 approaches the target blowing temperature TAO. The control signals and the like determined as described above are output from the air-conditioning control device 50 to various control devices.

Therefore, in the heat pump cycle 10 of the dehumidification heating mode, the high-pressure refrigerant discharged from the discharge port 11c of the compressor 11 flows into the interior condenser 12. At this time, since the air mixing door 44 fully opens the air passage of the interior condenser 12, the refrigerant that has flowed into the interior condenser 12 exchanges heat with the blown air cooled and dehumidified by the interior evaporator 26 to radiate the heat. As a result, the blown air is heated so as to approach the target blowing temperature TAO.

The refrigerant that has flowed out from the interior condenser 12 flows into the first pressure reducing mechanism 13, the gas-liquid separator 14, and the four-way valve 19 in the stated order in the same manner as in the cooling mode, and flows into the exterior heat exchanger 20.

The refrigerant that has flowed into the exterior heat exchanger 20 exchanges the heat with the outside air to radiate the heat and is cooled down to the target degree of subcooling. Further, the refrigerant that has flowed out of the exterior heat exchanger 20 flows into the low-pressure refrigerant passage 22, the second pressure reducing mechanism 25, the interior evaporator 26, the accumulator 30, and the compressor 11 in the stated order in the same manner as in the cooling mode.

As described above, in the dehumidification heating mode, the heat pump cycle 10 is configured such that the refrigerant radiates the heat in the interior condenser 12 and the exterior heat exchanger 20, and the refrigerant is evaporated in the interior evaporator 26. In the dehumidification heating mode, blown air, which has been cooled and dehumidified by the interior evaporator 26, can be heated and blown into the vehicle interior by the interior condenser 12. As a result, dehumidification heating in the vehicle interior can be achieved. In the dehumidification heating mode, since the intermediate opening and closing mechanism 16 is closed as in the cooling mode, the compressor 11 functions as a single-stage booster type compressor.

### (c) Heating Mode

The heating mode according to the present embodiment configures a first driving mode in which the exterior heat exchanger 20 functions as a heat exchanger for absorbing the heat from the outside air and the blown air is heated by the interior condenser 12. The heating mode according to the present embodiment is realized by controlling the pressure reducing mechanisms 13, 25, the intermediate opening and closing mechanism 16, and the four-way valve 19 with the air-conditioning control device 50.

More specifically, in the heating mode, the air-conditioning control device 50 sets the first pressure reducing mechanism 13 and the second pressure reducing mechanism 25 to be in the throttling state.

In addition, the air-conditioning control device 50 opens the intermediate opening and closing mechanism 16, and controls the four-way valve 19 so that the liquid-phase refrigerant outlet side of the gas-liquid separator 14 is connected to the interior evaporator 26, and the refrigerant inlet and outlet 20a of the exterior heat exchanger 20 is connected to the refrigerant inlet side of the accumulator 30.

As a result, in the heat pump cycle 10 of the heating mode, the refrigerant flows as indicated by arrows in FIG. 4. In other words, the discharged refrigerant discharged from the compressor 11 flows through the interior condenser 12, the first pressure reducing mechanism 13, the gas-liquid separator 14, the liquid-phase refrigerant passage 17, the four-way valve 19, the interior evaporator 26, the second pressure reducing mechanism 25, the low-pressure refrigerant passage 22, the exterior heat exchanger 20, the four-way valve 19, the accumulator 30, and the compressor 11 in the stated order. At this time, the gas-phase refrigerant separated by the gas-liquid separator 14 flows into the intermediate-pressure port 11b of the compressor 11 through the intermediate-pressure refrigerant passage 15.

In the cycle configuration described above, the operation state of each component of the heat pump cycle 10 is determined based on the target blowing temperature TAO calculated in step S104 and detection signals of various types of sensor groups.

For example, the control signal output to the electric motor of the compressor 11 is determined as follows. First, a target pressure Tpd of the pressure Pd of the high-pressure refrigerant that has passed through the interior condenser 12 is determined with reference to the control map stored in the memory in advance based on the target blowing temperature TAO. The rotational speed of the compressor 11 is determined based on a deviation between the target pressure Tpd and the pressure Pd of the high-pressure refrigerant so that the pressure Pd of the high-pressure refrigerant approaches the target pressure Tpd.

The control signal output to the first pressure reducing mechanism 13 is determined so that the degree of subcooling of the refrigerant flowing into the first pressure reducing mechanism 13 approaches the target degree of subcooling.

Moreover, a control signal to be output to the actuator for driving the air mixing door 44 is determined so that the air mixing door 44 closes the air passage on the cold air bypass passage 45 side, and a total flow rate of the blown air that has passed through the interior evaporator 26 passes through the interior condenser 12 side. The control signals and the like determined as described above are output from the air-conditioning control device 50 to various control devices.

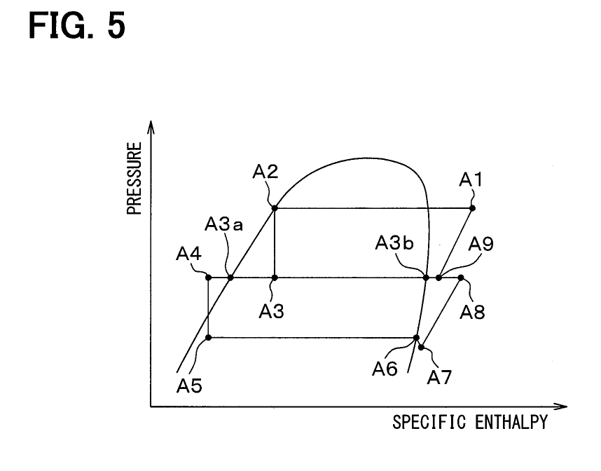

As a result, in the heat pump cycle 10 of the heating mode, a state of the refrigerant in the cycle changes as shown in a Mollier diagram of FIG. 5. In other words, as shown in FIG. 5, the high-pressure refrigerant (point A1 in FIG. 5) discharged from the discharge port 11c of the compressor 11 flows into the interior condenser 12, exchanges the heat with the blown air that has passed through the interior evaporator 26, and radiates the heat (from point A1 to point A2 in FIG. 5).

As a result, the blown air is heated so as to approach the target blowing temperature TAO.

The refrigerant that has flowed out from the interior condenser 12 flows into the first pressure reducing mechanism 13 subjected to the throttling state and is reduced in pressure down to an intermediate pressure (from point A2 to point A3 in FIG. 5). The intermediate-pressure refrigerant whose pressure has been reduced by the first pressure reducing mechanism 13 is separated into gas and liquid by the gas-liquid separator 14 (from point A3 to point A3a, and from point A3 to point A3b in FIG. 5).

Since the intermediate opening and closing mechanism 16 is open, the gas-phase refrigerant separated by the gas-liquid separator 14 flows into the intermediate-pressure port 11b of the compressor 11 through the intermediate-pressure refrigerant passage 15 (from point A3b to point A9 in FIG. 5).

The intermediate-pressure refrigerant that has flowed into the intermediate-pressure port 11b of the compressor 11 merges with the refrigerant (point A8 in FIG. 5) discharged from the low stage side compression unit and is drawn into the high stage side compression unit.

On the other hand, the liquid-phase refrigerant separated by the gas-liquid separator 14 flows into the interior evaporator 26 through the four-way valve 19. The refrigerant that has flowed into the interior evaporator 26 radiates the heat by heat exchange with the blown air blown from the blower 43, and an enthalpy of the refrigerant decreases (from A3a to A4 in FIG. 5). In other words, in the interior evaporator 26, the liquid-phase refrigerant separated by the gas-liquid separator 14 is subcooled. The refrigerant that has flowed out from the interior evaporator 26 flows into the second pressure reducing mechanism 25. At this time, since the second pressure reducing mechanism 25 is put in the throttling state, the refrigerant is depressurized by the second pressure reducing mechanism 25 (from A4 to A5 in FIG. 5). The refrigerant whose pressure has been reduced by the second pressure reducing mechanism 25 flows into the exterior heat exchanger 20 through the low-pressure refrigerant passage 22. The refrigerant that has flowed into the exterior heat exchanger 20 exchanges the heat with the outside air, absorbs the heat, and evaporates (from point A5 to point A6 in FIG. 5). The outside air corresponds to a heat medium.

Also, the refrigerant that has flowed out from the exterior heat exchanger 20 flows into the accumulator 30 through the four-way valve 19. The refrigerant that has flowed into the accumulator 30 is separated into gas and liquid in the gas-liquid separation unit 31 of the accumulator 30. The gas-phase refrigerant separated by the gas-liquid separation unit 31 of the accumulator 30 is drawn from the intake port 11a of the compressor 11 (point A7 in FIG. 5) and is compressed again in each compression unit of the compressor 11.

As described above, in the heating mode, the heat pump cycle 10 for causing the refrigerant to radiate the heat in the interior condenser 12 and evaporating the refrigerant in the exterior heat exchanger 20 is configured, and the blown air heated by the interior condenser 12 can be blown into the vehicle interior. As a result, heating in the vehicle interior can be realized.

According to the heat pump cycle 10 of the present embodiment described above, the driving modes such as the heating mode, the cooling mode, and the dehumidification heating mode can be switched under the control of each controlled equipment by the air-conditioning control device 50. In other words, in the heat pump cycle 10 according to the present embodiment, different functions such as heating, cooling, dehumidifying and heating in the vehicle interior can be realized.

In particular, the heat pump cycle 10 according to the present embodiment configures the refrigerant circuit that boosts the refrigerant in multiple stages, merges the intermediate-pressure refrigerant in the cycle with the refrigerant discharged from the low stage side compression unit of the compressor 11, and draws the merged refrigerant into the high stage side compression unit, in the heating mode. In other words, the heat pump cycle 10 is a gas injection cycle. This makes it possible to increase the density of the intake refrigerant drawn into the compressor 11 even in a low temperature environment where the outside air temperature becomes extremely low, as a result of which the heating capacity in the heat pump cycle 10 can be secured.

Further, the heat pump cycle 10 according to the present embodiment has the second pressure reducing mechanism 25 that reduces the liquid-phase refrigerant separated by the gas-liquid separator 14 down to a low-pressure refrigerant. In addition, the heat pump cycle 10 has the exterior heat exchanger 20 that performs heat exchange between the refrigerant that has passed through the second pressure reducing mechanism 25 and the outside air, and causes the refrigerant to flow out to the intake port side. In addition, the heat pump cycle 10 has the interior evaporator 26 that performs heat exchange between the liquid-phase refrigerant separated by the gas-liquid separator 14 and the counterpart fluid (that is, blown air) to cause the liquid-phase refrigerant to flow out to the second pressure reducing mechanism 25 side. In addition, the interior evaporator 26 is disposed on the upstream side of the interior condenser 12 in the flow direction of the heat exchange target fluid (that is, the blown air).

As described above, the interior evaporator 26 performs heat exchange between the liquid-phase refrigerant separated by the gas-liquid separator 14 and the counterpart fluid (that is, heat exchange target fluid) to subcool the liquid-phase refrigerant. With the configuration described above, the enthalpy of the refrigerant flowing into the exterior heat exchanger 20 can be reduced regardless of the refrigerant pressure of the intermediate-pressure port of the compressor. As a result, the amount of heat absorbed by the exterior heat exchanger 20 is increased, thereby being capable of increasing the amount of heat radiation of the refrigerant to the heat exchange target fluid.

Further, the interior evaporator 26 is disposed on the upstream side of the interior condenser 12. Therefore, the heat exchange target fluid high in temperature flows into the interior condenser 12, as a result of which the pressure of the refrigerant on the discharge side of the compressor 11 rises. As a result, a workload of the compressor 11 is increased, thereby being capable of further improving the heating capacity in the heat pump cycle.

Therefore, the heating capacity in the heat pump cycle can be improved regardless of the pressure of the intermediate-pressure refrigerant.

Further, the heat pump cycle 10 according to the present embodiment includes the four-way valve 19 that switches the refrigerant flow channel in the cycle to the first refrigerant flow channel and the second refrigerant flow channel. In the first refrigerant flow channel, the liquid-phase refrigerant separated by the gas-liquid separator 14 flows in the interior evaporator 26, the second pressure reducing mechanism 25, the exterior heat exchanger 20, and the compressor 11 in the stated order. In the second refrigerant flow channel, the liquid-phase refrigerant separated by the gas-liquid separator 14 flows in the exterior heat exchanger 20, the second pressure reducing mechanism 25, the interior evaporator 26, and the compressor 11 in the stated order. In addition, the heat pump cycle 10 includes a driving mode switching unit 50a that controls the four-way valve 19 to switch between the cooling mode for cooling the vehicle interior and the heating mode for heating the vehicle interior. The driving mode switching unit 50a switches the refrigerant flow channel in the cycle to the first refrigerant flow channel so that the interior evaporator 26 functions as a radiator in the heating mode, and switches the refrigerant flow channel in the cycle to the second refrigerant flow channel so that the interior evaporator 26 functions as a heat absorber in the cooling mode.

In this way, if the interior evaporator 26 that functions as a radiator in the heating mode is configured to function as a heat absorber in the cooling mode, an increase in the number of components of the cycle can be prevented.

### Second Embodiment

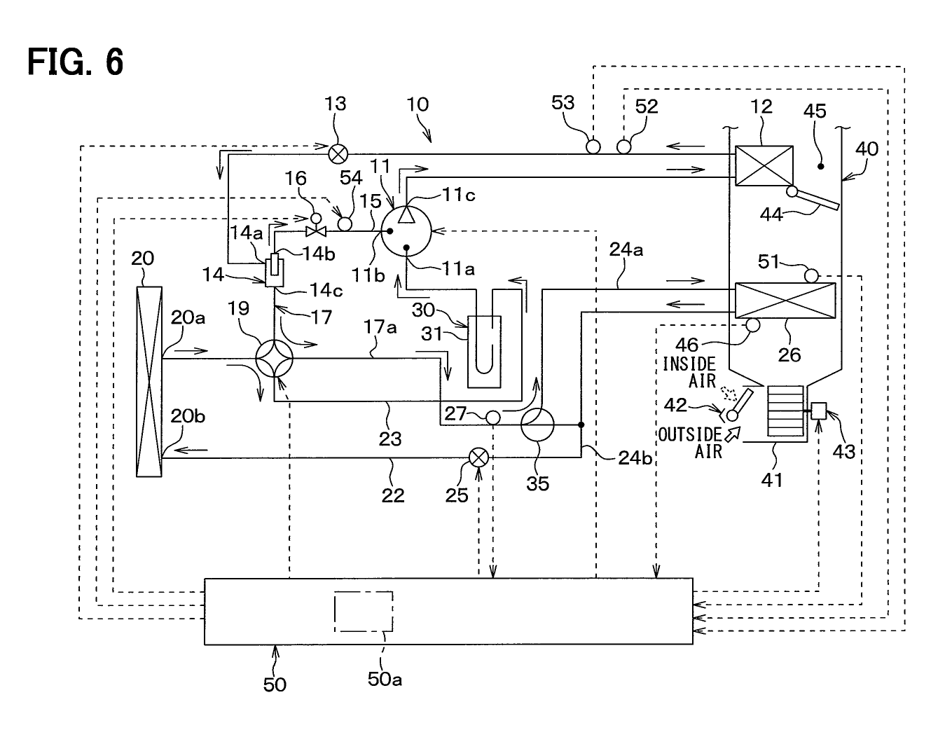

Next, a second embodiment will be described. FIG. 6 is a diagram illustrating an overall configuration of a heat pump cycle according to the second embodiment. The configuration of the heat pump cycle 10 according to the present embodiment is different from that of the first embodiment in that an intermediate flow channel switching unit 35 is further provided.

The intermediate flow channel switching unit 35 is configured by a three-way valve for switching between an intermediate heat exchange flow channel 24a for allowing a liquid-phase refrigerant separated by a gas-liquid separator 14 and passing through a four-way valve 19 to flow into an interior evaporator 26, and an intermediate bypass flow channel 24b for allowing the liquid-phase refrigerant to bypass the interior evaporator 26. The operation of the intermediate flow channel switching unit 35 is controlled according to a control signal output from an air-conditioning control device 50.

In the heat pump cycle 10 described above, when an outside air temperature is higher than a temperature of the liquid-phase refrigerant flowing into the interior evaporator 26 from a gas-liquid separator 14 in a heating mode, the interior evaporator 26 functions as a heat absorber. Therefore, the heating performance is deteriorated. For that reason, the air-conditioning control device 50 according to the present embodiment implements a process of switching a flow channel of the refrigerant so that the interior evaporator 26 does not function as a heat absorber when an outside air temperature is higher than a temperature of the liquid-phase refrigerant flowing into the interior evaporator 26 from the gas-liquid separator 14 in the heating mode.

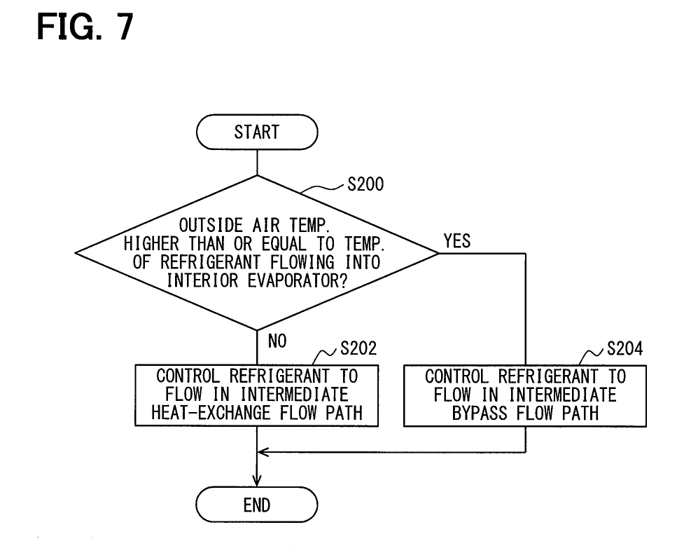

FIG. 7 is a flowchart illustrating the above process. In the heating mode, the air-conditioning control device 50 performs a process shown in FIG. 7 in parallel with the process shown in FIG. 2. In this case, it is assumed that a suction port mode is set to an outside air mode. When an operation switch of the vehicle air conditioning apparatus is turned on, the air-conditioning control device 50 first determines whether the outside air temperature is equal to or higher than a temperature of the liquid-phase refrigerant flowing into the interior evaporator 26 from the gas-liquid separator 14, or not (S200). Specifically, the air-conditioning control device 50 specifies the temperature detected by a refrigerant temperature detection unit 54 or a refrigerant temperature sensor 27, and specifies the temperature detected by a temperature sensor 46. The refrigerant temperature detection unit 54 detects the temperature of the refrigerant passing through an intermediate-pressure refrigerant passage 15. The temperature detected by the refrigerant temperature detection unit 54 or the refrigerant temperature sensor 27 corresponds to the temperature of the liquid-phase refrigerant separated by the gas-liquid separator 14 and flowing into the interior evaporator 26. The temperature detected by the temperature sensor 46 corresponds to an outside air temperature flowing into the interior evaporator 26. It is determined whether the outside air temperature is equal to or higher than the temperature of the liquid-phase refrigerant flowing into the interior evaporator 26, or not. It should be noted that S200 corresponds to a temperature determination unit.

In this case, when the outside air temperature is lower than the temperature of the liquid-phase refrigerant flowing into the interior evaporator 26 from the gas-liquid separator 14, the determination in S200 is NO. In this case, the air-conditioning control device 50 controls the intermediate flow channel switching unit 35 so that the liquid-phase refrigerant that has flowed out from the gas-liquid separator 14 flows into the interior evaporator 26 through the four-way valve 19 and the intermediate heat exchange flow channel 24a.

As a result, the liquid-phase refrigerant that has flowed out from the gas-liquid separator 14 flows in the four-way valve 19, the interior evaporator 26, the second pressure reducing mechanism 25, the exterior heat exchanger 20, the four-way valve 19, the accumulator 30, and the compressor 11 in the stated order.

At this time, the interior evaporator 26 performs heat exchange between the liquid-phase refrigerant separated by the gas-liquid separator 14 and the blown air blown into the vehicle interior, which is an air-conditioning target space, to subcool the liquid-phase refrigerant. For that reason, the enthalpy of the refrigerant flowing into the interior evaporator 26 can be reduced regardless of the refrigerant pressure of an intermediate-pressure port of the compressor.

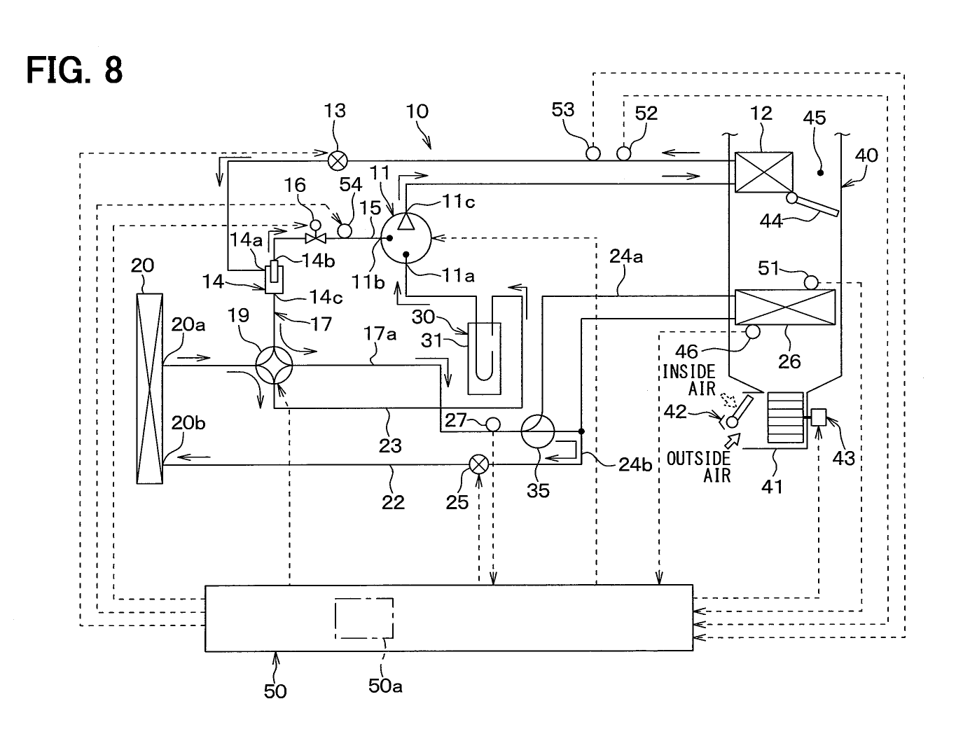

When the temperature detected by the temperature sensor 46, that is, the outside air temperature flowing into the interior evaporator 26 is equal to or higher than the temperature of the liquid-phase refrigerant flowing into the interior evaporator 26 from the gas-liquid separator 14, the determination in S200 is YES. In this case, the liquid-phase refrigerant that has flowed out from the gas-liquid separator 14 flows as indicated by arrows in FIG. 8. In other words, the liquid-phase refrigerant that has flowed out from the gas-liquid separator 14 flows through the four-way valve 19 and the intermediate flow channel switching unit 35, and thereafter flows into the second pressure reducing mechanism 25 while bypassing the interior evaporator 26. More specifically, the liquid-phase refrigerant that has flowed out of the gas-liquid separator 14 flows in the four-way valve 19, the second pressure reducing mechanism 25, the exterior heat exchanger 20, the four-way valve 19, the accumulator 30, and the compressor 11 in the stated order.

At this time, the liquid-phase refrigerant that has flowed out from the gas-liquid separator 14 does not flow into the interior evaporator 26. For that reason, even when the outside air temperature is higher than the temperature of the liquid-phase refrigerant flowing into the interior evaporator 26 from the gas-liquid separator 14, the interior evaporator 26 is prevented from functioning as a heat absorber. Therefore, the heating performance does not deteriorate.

As described above, the heat pump cycle 10 according to the present embodiment includes the intermediate flow channel switching unit 35 and the air-conditioning control device 50 that controls the intermediate flow channel switching unit 35. The intermediate flow channel switching unit 35 switches the refrigerant flow channel within the cycle between the intermediate heat exchange flow channel 24a that allows the refrigerant to flow into the interior evaporator 26 and the intermediate bypass flow channel 24b that allows the refrigerant to bypass the interior evaporator 26. The air-conditioning control device 50 determines whether the temperature detected by the temperature sensor 46, that is, the outside air temperature flowing into the interior evaporator 26 is equal to or higher than the temperature of the liquid-phase refrigerant flowing into the interior evaporator 26 from the gas-liquid separator 14, or not. When it is determined that the outside air temperature flowing into the interior evaporator 26 is lower than the temperature of the liquid-phase refrigerant flowing into the interior evaporator 26 from the gas-liquid separator 14, the air-conditioning control device 50 controls the intermediate flow channel switching unit 35 so that the refrigerant flow channel in the cycle flows in the intermediate heat exchange flow channel 24a.

As a result, the interior evaporator 26 performs heat exchange between the liquid-phase refrigerant separated by the gas-liquid separator 14 and the blown air that is blown into the vehicle interior, which is the air-conditioning target space, to subcool the liquid-phase refrigerant. For that reason, even if the refrigerant pressure of the intermediate-pressure port of the compressor rises, the enthalpy of the refrigerant flowing into the interior evaporator 26 can be reduced. As a result, the amount of heat absorbed by the interior heat exchanger 26 is increased, thereby being capable of increasing the amount of heat radiation of the refrigerant to the heat exchange target fluid.

Further, in the present embodiment, the air-conditioning control device 50 determines whether the temperature detected by the temperature sensor 46, that is, the outside air temperature flowing into the interior evaporator 26, is equal to or higher than the temperature of the liquid-phase refrigerant flowing into the interior evaporator 26 from the gas-liquid separator 14, or not. When it is determined whether the outside air temperature is equal to or higher than the temperature of the liquid-phase refrigerant flowing into the interior evaporator 26 from the gas-liquid separator 14, the air-conditioning control device 50 controls the intermediate flow channel switching unit 35 so as to allow the refrigerant flow channel in the cycle to bypass the interior evaporator 26 so that the refrigerant flows in the intermediate bypass flow channel 24b. Therefore, even if the outside air temperature is higher than the temperature of the liquid-phase refrigerant flowing into the interior evaporator 26 from the gas-liquid separator 14, the interior evaporator 26 can be prevented from functioning as the heat absorber.

In the present embodiment, the suction port mode is set to the outside air mode, and in S200, it is determined whether the outside air temperature is equal to or higher than the temperature of the liquid-phase refrigerant flowing from the gas-liquid separator 14 into the interior evaporator 26, or not. However, for example, when the suction port mode is set to the inside air mode, the air-conditioning control device 50 may make a different determination in S200. More specifically, the air-conditioning control device 50 may determine whether the temperature detected by the temperature sensor 46, that is, the inside air temperature flowing into the interior evaporator 26 is equal to or higher than the temperature of the liquid-phase refrigerant flowing into the interior evaporator 26 from the gas-liquid separator 14, or not.

When the inside air temperature is lower than the temperature of the liquid-phase refrigerant flowing into the interior evaporator 26 from the gas-liquid separator 14, the air-conditioning control device 50 may control the intermediate flow channel switching unit 35 so that the liquid-phase refrigerant that has flowed out from the gas-liquid separator 14 flows into the interior evaporator 26 through the four-way valve 19 and the intermediate heat exchange flow channel 24a. Further, when it is determined that the inside air temperature is equal to or higher than the temperature of the liquid-phase refrigerant flowing into the interior evaporator 26 from the gas-liquid separator 14, the air-conditioning control device 50 may control the intermediate flow channel switching unit 35 so that the refrigerant flows into the intermediate bypass flow channel 24b that allows the refrigerant flow channel in the cycle to bypass the interior evaporator 26.

### Third Embodiment

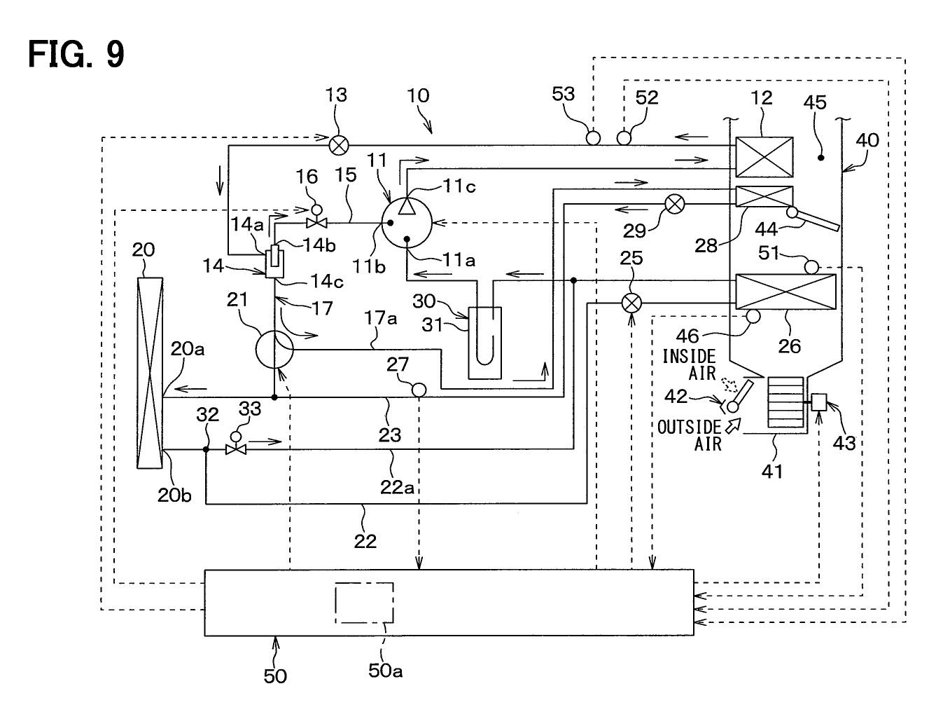

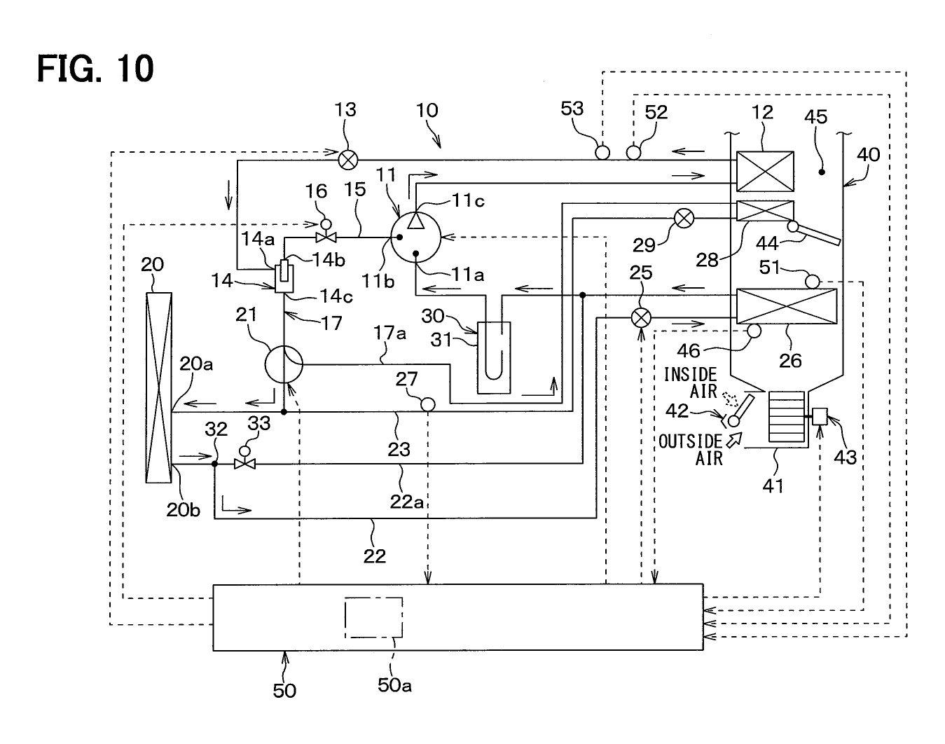

Next, a second embodiment will be described. FIGS. 9 and 10 are diagrams illustrating an overall configuration of a heat pump cycle according to the third embodiment. In each of the above embodiments, the heat pump cycle 10 utilizes the interior evaporator 26 as the second usage side heat exchanger in the heating mode and subcools the liquid-phase refrigerant separated by the gas-liquid separator 14. On the other hand, in the present embodiment, a heat pump cycle 10 newly includes a condenser 28 as a second usage side heat exchanger and also newly includes a third pressure reducing mechanism 29 as a second pressure reducing unit. Furthermore, in the present embodiment, the heat pump cycle 10 includes a three-way valve 21 instead of the four-way valve 19 and includes a low-pressure opening and closing mechanism 33 that opens and closes a low-pressure bypass passage 22a.

In the present embodiment, the condenser 28 corresponds to a second usage side heat exchanger, the third pressure reducing mechanism 29 corresponds to a second pressure reducing unit, the interior evaporator 26 corresponds to a third usage side heat exchanger, and the second pressure reducing mechanism 25 corresponds to a third pressure reducing unit.

A branch portion 32 that branches off a refrigerant that has flowed out of an exterior heat exchanger 20 is connected to a refrigerant inlet and outlet 20b of the exterior heat exchanger 20. A low-pressure refrigerant passage 22 and a low-pressure bypass passage 22a are connected to the branch portion 32.

The low-pressure refrigerant passage 22 is a refrigerant passage that leads the refrigerant that has flowed out from the refrigerant inlet and outlet 20b of the exterior heat exchanger 20 to an accumulator 30 through the second pressure reducing mechanism 25 and the interior evaporator 26.

The low-pressure bypass passage 22a is a refrigerant passage that leads the refrigerant that has flowed out from the refrigerant inlet and outlet 20b of the exterior heat exchanger 20 to an accumulator 30 while bypassing the second pressure reducing mechanism 25 and the interior evaporator 26. A low-pressure opening and closing mechanism 33 for opening and closing the low-pressure bypass passage 22a is provided in the low-pressure bypass passage 22a.

The three-way valve 21 is a refrigerant flow channel switching unit that switches between a refrigerant flow path of the heat pump cycle 10 during a vehicle interior cooling and a refrigerant flow path of the heat pump cycle 10 during a vehicle interior heating.

More specifically, the three-way valve 21 connects a liquid-phase refrigerant outlet side of the gas-liquid separator 14 to the refrigerant inlet and outlet 20a of the exterior heat exchanger 20 during vehicle interior cooling. In addition, the air-conditioning control device 50 closes the low-pressure opening and closing mechanism 33 and narrows the second pressure reducing mechanism 25 during the vehicle interior cooling. As a result, as indicated by arrows in FIG. 9, the refrigerant discharged from the compressor 11 flows through the interior condenser 12, the first pressure reducing mechanism 13, the gas-liquid separator 14, the three-way valve 21, the exterior heat exchanger 20, the second pressure reducing mechanism 25, the interior evaporator 26, and the accumulator 30 in the stated order, and is again drawn into the compressor 11.

Further, during vehicle interior heating, the three-way valve 21 connects the liquid-phase refrigerant outlet side of the gas-liquid separator 14 to the condenser 28 through the refrigerant pipe 17a. In addition, the air-conditioning control device 50 opens the low-pressure opening and closing mechanism 33 and narrows the second pressure reducing mechanism 25 during the vehicle interior heating. As a result, as indicated by arrows in FIG. 10, the refrigerant discharged from the compressor 11 flows through the interior condenser 12, the first pressure reducing mechanism 13, the gas-liquid separator 14, the three-way valve 21, the condenser 28, the third pressure reducing mechanism 29, the exterior heat exchanger 20, the low-pressure opening and closing mechanism 29, the exterior heat exchanger 20, the low-pressure opening and closing mechanism 33, and the accumulator 30 in the stated order, and is again drawn into the compressor 11.

In addition, the condenser 28 is a second usage side heat exchanger that performs heat exchange between the liquid-phase refrigerant separated by the gas-liquid separator 14 and the heat exchange target fluid to cause the liquid-phase refrigerant to flow out to the third pressure reducing mechanism 29 side. The condenser 28 is disposed in the air conditioning case 41 on the upstream side of the interior condenser 12 in the flow direction of the heat exchange target fluid and on the downstream side of the interior evaporator 26 in the flow direction of the heat exchange target fluid. The third pressure reducing mechanism 29 is a second pressure reducing unit that reduces the pressure of the refrigerant that has flowed out from the condenser 28 down to a low-pressure refrigerant.

In the configuration described above, in the heat pump cycle 10 in the heating mode, the high-pressure refrigerant discharged from the discharge port 11c of the compressor 11 flows into the interior condenser 12 and exchanges the heat with the blown air that has passed through the interior evaporator 26 to radiate the heat. As a result, the blown air is heated so as to approach the target blowing temperature TAO.

The refrigerant that has flowed out from the interior condenser 12 flows into the first pressure reducing mechanism 13 subjected to the throttling state and is reduced in pressure down to an intermediate pressure. The intermediate-pressure refrigerant whose pressure has been reduced by the first pressure reducing mechanism 13 is separated into gas and liquid by the gas-liquid separator 14.

Since the intermediate opening and closing mechanism 16 is open, the gas-phase refrigerant separated by the gas-liquid separator 14 flows into the intermediate-pressure port 11b of the compressor 11 through the intermediate-pressure refrigerant passage 15. The intermediate-pressure refrigerant that has flowed into the intermediate-pressure port 11b of the compressor 11 merges with the refrigerant discharged from the low stage side compression unit and is drawn into the high stage side compression unit.

On the other hand, the liquid-phase refrigerant separated by the gas-liquid separator 14 flows into the condenser 28 through the three-way valve 21. The refrigerant that has flowed into the condenser 28 radiates the heat by heat exchange with the blown air blown from the blower 43, and an enthalpy of the refrigerant decreases. In other words, in the condenser 28, the liquid-phase refrigerant separated by the gas-liquid separator 14 is subcooled. The refrigerant that has flowed out from the condenser 28 flows into the third pressure reducing mechanism 29. At this time, since the third pressure reducing mechanism 29 is put in the throttling state, the pressure of the refrigerant is reduced by the third pressure reducing mechanism 29. The refrigerant whose pressure has been reduced by the third pressure reducing mechanism 29 flows into the exterior heat exchanger 20 through the low-pressure refrigerant passage 23. The refrigerant that has flowed into the exterior heat exchanger 20 exchanges the heat with the outside air, absorbs the heat, and evaporates.

Also, the refrigerant that has flowed out from the exterior heat exchanger 20 flows into the accumulator 30 through the low-pressure opening and closing mechanism 33. The refrigerant that has flowed into the accumulator 30 is separated into gas and liquid in the gas-liquid separation unit 31 of the accumulator 30. The gas-phase refrigerant separated by the gas-liquid separation unit 31 of the accumulator 30 is drawn from the intake port 11a of the compressor 11 and is compressed again in each compression unit of the compressor 11.

Further, the heat pump cycle 10 according to the present embodiment described above has the third pressure reducing mechanism 29 that reduces the liquid-phase refrigerant separated by the gas-liquid separator 14 down to a low-pressure refrigerant. In addition, the heat pump cycle 10 has the exterior heat exchanger 20 that performs heat exchange between the refrigerant that has passed through the third pressure reducing mechanism 29 and the outside air, and causes the refrigerant to flow out to the intake port side. In addition, the heat pump cycle 10 has the condenser 28 that performs heat exchange between the liquid-phase refrigerant separated by the gas-liquid separator 14 and the heat exchange target fluid to cause the liquid-phase refrigerant to flow out to the second pressure reducing mechanism 25 side. In addition, the condenser 28 is disposed on the upstream side of the interior condenser 12 in the flow direction of the heat exchange target fluid.

As described above, the condenser 28 performs heat exchange between the liquid-phase refrigerant separated by the gas-liquid separator 14 and the heat exchange target fluid to subcool the liquid-phase refrigerant. This makes it possible to reduce the enthalpy of the refrigerant flowing into the exterior heat exchanger 20 regardless of the refrigerant pressure of the intermediate-pressure port of the compressor. As a result, the amount of heat absorbed by the exterior heat exchanger 20 is increased, thereby being capable of increasing the amount of heat radiation of the refrigerant to the heat exchange target fluid.

In addition, in the present embodiment, the heat pump cycle 10 has an interior evaporator 26 that performs heat exchange between the refrigerant that has flowed out from the exterior heat exchanger 20 and the counterpart fluid (that is, the heat exchange target fluid). Further, the heat pump cycle 10 has the second pressure reducing mechanism 25 that reduces the pressure of the refrigerant before flowing into the interior evaporator 26. Further, the heat pump cycle 10 has the three-way valve 21. The three-way valve 21 switches the refrigerant flow channel in the cycle between the third refrigerant flow channel and the fourth refrigerant flow channel. In the third refrigerant flow channel, the liquid-phase refrigerant separated by the gas-liquid separator 14 flows through the condenser 28, the third pressure reducing mechanism 29, the exterior heat exchanger 20, and the compressor 11 in the stated order. In the fourth refrigerant flow channel, the liquid-phase refrigerant separated by the gas-liquid separator 14 flows in the exterior heat exchanger 20, the second pressure reducing mechanism 25, the interior evaporator 26, and the compressor 11 in the stated order. In addition, the heat pump cycle 10 has a driving mode switching unit 50a. The driving mode switching unit 50a controls the three-way valve 21 to switch between the cooling mode for cooling the vehicle interior and the heating mode for heating the vehicle interior. The driving mode switching unit 50a may switch the refrigerant flow channel in the cycle to the third refrigerant flow channel so that the condenser 28 functions as a radiator in the heating mode. In this case, the driving mode switching unit 50a can switch the refrigerant flow channel in the cycle to the fourth refrigerant flow channel so that the interior evaporator 26 functions as a heat absorber in the cooling mode.

### Fourth Embodiment

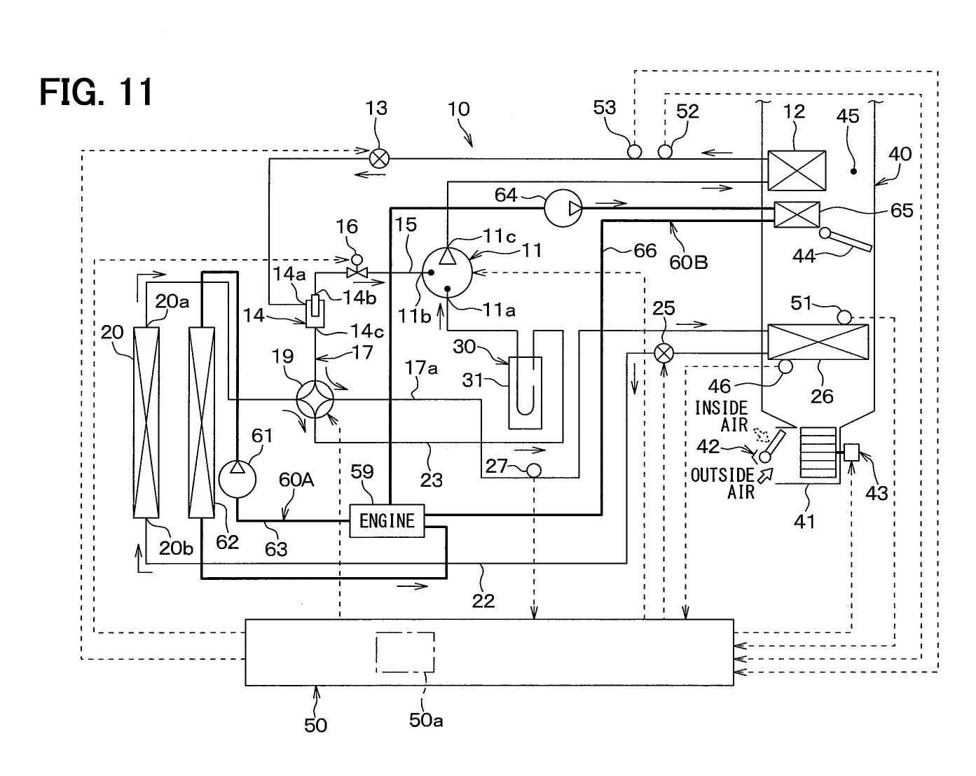

Hereinafter, a description will be given of a fourth embodiment with reference to FIG. 11. In a heating mode, an exterior heat exchanger 20 according to the present embodiment exchanges a heat between an air heated by a coolant for cooling an engine 59 and a refrigerant. In the present embodiment, the air heated by the coolant corresponds to a heating medium. The air heated by the coolant is an example of an outside air.

As shown in FIG. 11, a vehicle to which a vehicle air conditioning apparatus according to the present embodiment is applied has an engine 59 and engine cooling circuits 60A and 60B. The other configurations are the same as those in the first embodiment.

The engine 59 is an internal combustion engine that generates a vehicle traveling power by burning a fuel such as gasoline. The engine cooling circuit 60A circulates a coolant, and has a water pump 61, a radiator 62, and a coolant pipe 63. The radiator 62 is disposed close to and facing the exterior heat exchanger 20.

When the water pump 61 is operated, the coolant circulates in the engine cooling circuit 60A. Specifically, the water pump 61 draws the coolant in the coolant pipe 63 from an inlet of a water pump 61, and discharges the coolant from an outlet of the water pump 61 to the coolant pipe 63. The coolant discharged from the outlet of the water pump 61 reaches an inlet of the radiator 62 through the coolant pipe 63 and flows into the radiator 62 from the inlet of the radiator 62. The refrigerant that has flowed into the radiator 62 flows out from the outlet of the radiator 62 to the coolant pipe 63. The refrigerant that has flowed out from the radiator 62 passes through the inside of the engine 59 through the coolant pipe 63, and then reaches an inlet of the water pump 61.

The engine cooling circuit 60B is another circuit different from the engine cooling circuit 60A for circulating the coolant, and has a water pump 64, a heater core 65, and a coolant pipe 66.

In the air conditioning case 41, the heater core 65 is disposed on an air flow upstream side of the interior condenser 12 and on an air flow downstream side of the interior evaporator 26. Further, the heater core 65 is disposed on the air flow downstream side of the air mixing door 44.

When the water pump 64 is operated, the coolant circulates in the engine cooling circuit 60B. Specifically, the water pump 64 draws the coolant in the coolant pipe 66 from an inlet of a water pump 64, and discharges the coolant from an outlet of the water pump 64 to the coolant pipe 66. The coolant discharged from the outlet of the water pump 64 reaches an inlet of the heater core 65 through the coolant pipe 66 and flows into the heater core 65 from the inlet of the heater core 65. The refrigerant that has flowed into the heater core 65 flows out from the outlet of the heater core 65 to the coolant pipe 66. The refrigerant that has flowed out from the heater core 65 passes through the inside of the engine 59 through the coolant pipe 66, and then reaches an inlet of the water pump 64.

Hereinafter, the operation of the present embodiment will be described. In the present embodiment, the water pumps 61 and 64 are always operated during the operation of the heat pump cycle 10.

Therefore, in the engine cooling circuit 60A, the coolant which has taken a heat from the engine 59 and becomes high temperature flows into the radiator 62, is cooled by heat exchange with the outside air inside the radiator 62, and then returns to the engine 59. Also, the coolant is circulated in the engine cooling circuit 60B.

The operation of the heat pump cycle 10 in the cooling mode is the same as that in the first embodiment. However, in the cooling mode, the air mixing door 44 closes the air passage on the side of the interior condenser 12 and the heater core 65. Therefore, the coolant that has flowed into the heater core 65 flows out from the heater core 65 without almost radiating the heat to the blown air.

Further, in the cooling mode, an exterior fan not shown operates to draw and blow out the outside air. With the exterior fan, the outside air passes through the exterior heat exchanger 20 and the radiator 62 in the stated order. As a result, the refrigerant passing through the inside of the exterior heat exchanger 20 and the coolant passing through the inside of the radiator 62 exchanges heat with the outside air and is cooled.

The operation of the heat pump cycle 10 in the dehumidification heating mode is the same as that in the first embodiment. However, in the dehumidification heating mode, the air mixing door 44 closes the cold air bypass passage 45, and the total flow rate of the blown air after having passed through the interior evaporator 26 passes through the heater core 65 and the interior condenser 12. Therefore, the blown air after having passed through the interior evaporator 26 is heated by exchanging the heat with the coolant in the heater core 65. At the same time, the coolant is cooled in the heater core 65.

Further, in the dehumidification heating mode, the exterior fan described above operates to draw and blow out the outside air. With the exterior fan, the outside air passes through the exterior heat exchanger 20 and the radiator 62 in the stated order. As a result, the refrigerant passing through the inside of the exterior heat exchanger 20 and the coolant passing through the inside of the radiator 62 exchanges heat with the outside air and is cooled.

The operation of the heat pump cycle 10 in the heating mode is the same as that in the first embodiment. However, in the heating mode, the air mixing door 44 closes the cold air bypass passage 45, and the total flow rate of the blown air after having passed through the interior evaporator 26 passes through the heater core 65 and the interior condenser 12. Therefore, the blown air after having passed through the interior evaporator 26 is heated by exchanging the heat with the coolant in the heater core 65. At the same time, the coolant is cooled in the heater core 65.

Further, in the heating mode, the exterior fan described above operates to draw and blow out the outside air. However, at this time, the exterior fan rotates in a direction opposite to the cooling mode and dehumidification heating mode. With the operation of the exterior fan, the outside air passes through the radiator 62 and the exterior heat exchanger 20 in the stated order.

As a result, the outside air first exchanges the heat with the coolant passing through the inside of the radiator 62 when passing through the radiator 62. As a result, the outside air is warmed and the coolant is cooled.

The outside air that has been heated through the radiator 62 passes through the exterior heat exchanger 20. At this time, the heated outside air exchanges the heat with the refrigerant passing through the inside of the exterior heat exchanger 20. As a result, the outside air is cooled and the refrigerant passing through the inside of the exterior heat exchanger 20 is warmed and evaporated.

### Fifth Embodiment

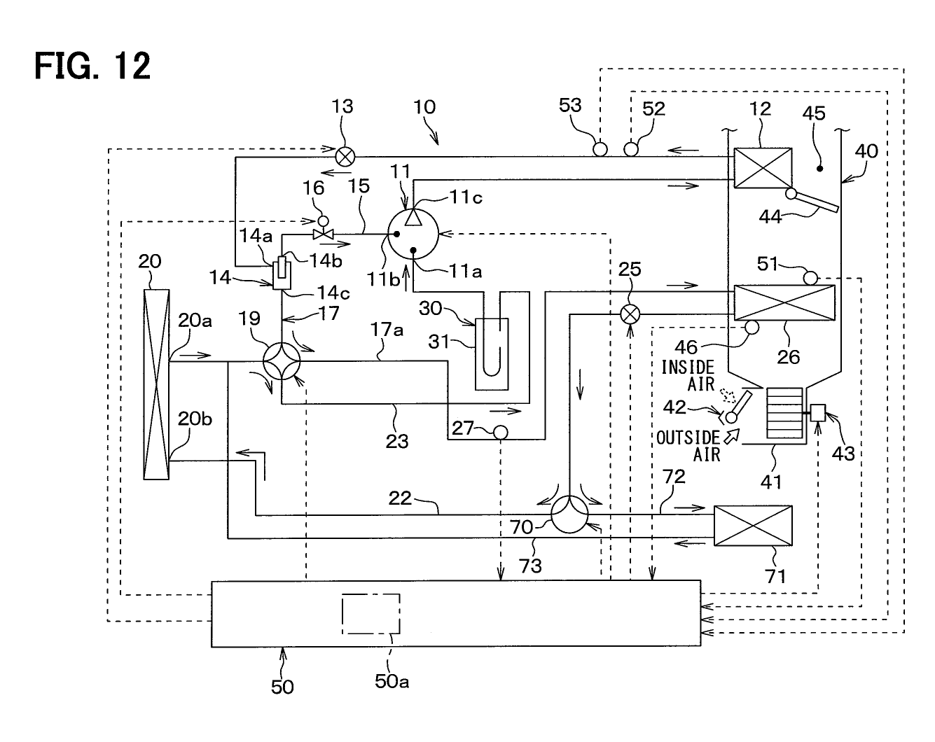

Next, a fifth embodiment will be described with reference to FIG. 12. As shown in FIG. 12, in addition to the configuration of the heat pump cycle 10 according to the first embodiment, a heat pump cycle 10 according to the present embodiment further includes a three-way valve 70, a ventilation heat recovery heat exchanger 71, an additional passage 72, and an additional passage 73. In the present embodiment, the ventilation heat recovery heat exchanger 71 also corresponds to an additional heat exchanger and also corresponds to an exterior heat exchanger.

The three-way valve 70 is disposed in a low-pressure refrigerant passage 22 and connected to the additional passage 72. The three-way valve 70 is configured to be switchable between a non-recovery state and a recovery state according to a control signal output from the air-conditioning control device 50. In the non-recovery state, the three-way valve 70 communicates a portion of the low-pressure refrigerant passage 22 on the side of the exterior heat exchanger 20 with a portion on the side of the second pressure reducing mechanism 25. In the recovery state, the three-way valve 70 communicates a portion of the low-pressure refrigerant passage 22 on the side of the second pressure reducing mechanism 25 with the additional passage 72.

The ventilation heat recovery heat exchanger 71 is disposed in a passage not shown for discharging the inside air from the vehicle interior to the vehicle exterior for ventilation. The refrigerant flows into the ventilation heat recovery heat exchanger 71 from an inlet of the ventilation heat recovery heat exchanger 71 and passes through the inside of the ventilation heat recovery heat exchanger 71, and thereafter flows out of the ventilation heat recovery heat exchanger 71 from an outlet of the ventilation heat recovery heat exchanger 71. The refrigerant passing through the inside of the ventilation heat recovery heat exchanger 71 is heated by exchanging the heat with the inside air passing through the ventilation heat recovery heat exchanger 71.

One end of the additional passage 72 is connected to the three-way valve, and the other end is connected to the inlet of the ventilation heat recovery heat exchanger 71. One end of the additional passage 73 is connected to the outlet of the ventilation heat recovery heat exchanger 71, and the other end of the additional passage 73 is connected to a passage between an refrigerant inlet and outlet 20a of the exterior heat exchanger 20 and a four-way valve 19.

Hereinafter, the operation of the present embodiment will be described. The operation in the cooling mode and the dehumidification heating mode is the same as in the first embodiment except that the air-conditioning control device 50 switches the three-way valve 70 to the non-recovery state. Therefore, in the cooling mode and the dehumidification heating mode, no refrigerant flows through the ventilation heat recovery heat exchanger 71 and the additional passages 72, 73.

The control contents of the air-conditioning control device 50 in the heating mode are the same as that of the first embodiment except for the control contents of the three-way valve 70. In the heating mode, there are cases where the air-conditioning control device 50 switches the three-way valve 70 to the non-recovery state and the recovery state. Specifically, when a predetermined condition is satisfied, the air-conditioning control device 50 switches the three-way valve 70 to the recovery state, and switches the three-way valve 70 to the non-recovery state otherwise. The predetermined condition includes, for example, a case where the inside air temperature is higher than a predetermined temperature.

The operation of the heat pump cycle 10 when the three-way valve 70 is in the non-recovery state is the same as that in the first embodiment. In this case, no refrigerant flows through the ventilation heat recovery heat exchanger 71 and the additional passages 72, 73.

When the three-way valve 70 is in the recovery state, no refrigerant flows through the exterior heat exchanger 20 and the second pressure reducing mechanism 25 side portion of the low-pressure refrigerant passage 22. Therefore, although a flow channel in which the refrigerant whose pressure has been reduced by the second pressure reducing mechanism 25 reaches the four-way valve 19 is different from that in the first embodiment, the other refrigerant flow channels are the same as in the first embodiment.

The refrigerant whose pressure has been reduced by the second pressure reducing mechanism 25 enters the additional passage 72 from the three-way valve 70 and flows into the ventilation heat recovery heat exchanger 71 through the additional passage 72. The refrigerant that has passed into the ventilation heat recovery heat exchanger 71 exchanges the heat with the inside air passing through the ventilation heat recovery heat exchanger 71, and evaporates. The refrigerant that has flowed out from the ventilation heat recovery heat exchanger 71 flows into the accumulator 30 through the additional passage 73 and the four-way valve 19.

As described above, in the heating mode, the ventilation heat recovery heat exchanger 71 performs heat exchange between the inside air discharged for ventilation from the vehicle interior and the refrigerant. In other words, in the heating mode, the ventilation heat recovery heat exchanger 71 leverages the ventilation heat to heat the refrigerant. In the present embodiment, in addition to the outside air, the inside air discharged from the vehicle interior for ventilation also corresponds to a heat medium.

### Sixth Embodiment

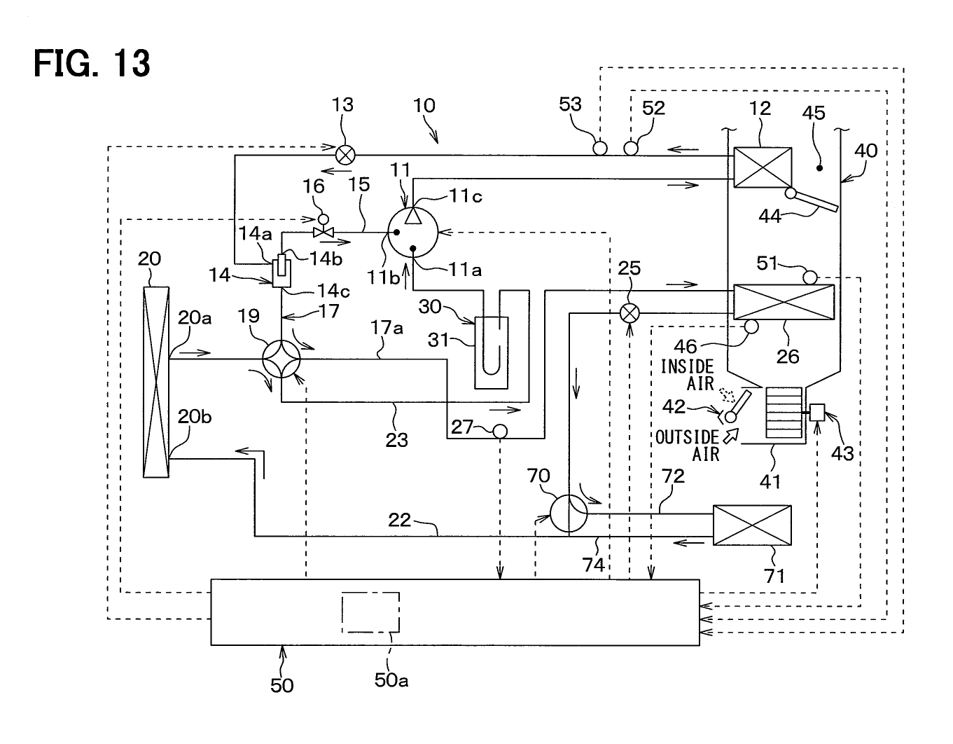

Next, a sixth embodiment will be described with reference to FIG. 13. In a heat pump cycle 10 according to the present embodiment, the additional passage 73 is replaced with an additional passage 74 in the configuration of the heat pump cycle 10 according to the fifth embodiment. One end of the additional passage 74 is connected to the outlet of the ventilation heat recovery heat exchanger 71, and the other end of the additional passage 73 is connected between the refrigerant inlet and outlet 20b of the exterior heat exchanger 20 and the three-way valve 70 in the low-pressure refrigerant passage 22. In the present embodiment, the ventilation heat recovery heat exchanger 71 also corresponds to an exterior heat exchanger.

Hereinafter, the operation of the present embodiment will be described. The operation in the cooling mode and the dehumidification heating mode is the same as that in the fifth embodiment. Therefore, in the cooling mode and the dehumidification heating mode, no refrigerant flows through the ventilation heat recovery heat exchanger 71 and the additional passages 72, 74.

The control contents of the air-conditioning control device 50 in the heating mode are the same as that of the fifth embodiment except for the control contents of the three-way valve 70. In the heating mode, the air-conditioning control device 50 switches the three-way valve 70 to the recovery state.

Therefore, in the heating mode, no refrigerant flows through the passage that bypasses the additional passage 72 and the ventilation heat recovery heat exchanger 71 in the three-way valve 70. Therefore, although a flow channel in which the refrigerant whose pressure has been reduced by the second pressure reducing mechanism 25 reaches the exterior heat exchanger 20 is different from that in the fifth embodiment, the other refrigerant flow channels are the same as in the fifth embodiment. The refrigerant whose pressure has been reduced by the second pressure reducing mechanism 25 enters the additional passage 72 from the three-way valve 70 and flows into the ventilation heat recovery heat exchanger 71 through the additional passage 72. The refrigerant that has passed into the ventilation heat recovery heat exchanger 71 exchanges the heat with the inside air passing through the ventilation heat recovery heat exchanger 71, and absorbs the heat. As a result, a part of the refrigerant evaporates. The refrigerant that has flowed out from the ventilation heat recovery heat exchanger 71 flows into the exterior heat exchanger 20 through the additional passage 74 and the exterior heat exchanger 20 side of the low-pressure refrigerant passage 22. The refrigerant that has flowed into the exterior heat exchanger 20 exchanges the heat with the outside air, absorbs the heat, and absorbs the heat. As a result, the remaining part of the refrigerant evaporates. The refrigerant that has flowed out from the exterior heat exchanger 20 flows into the accumulator 30 after having passed through the four-way valve 19 and the low-pressure refrigerant passage 23.

As described above, in the present embodiment, in the heating mode, the ventilation heat recovery heat exchanger 71 and the exterior heat exchanger 20 are connected in series in the stated order along the flow of the refrigerant. As described above, in the heating mode, the ventilation heat recovery heat exchanger 71 performs heat exchange between the inside air discharged for ventilation from the vehicle interior and the refrigerant. In other words, in the heating mode, the ventilation heat recovery heat exchanger 71 leverages the ventilation heat to heat the refrigerant. In the present embodiment, in addition to the outside air, the inside air discharged from the vehicle interior for ventilation also corresponds to a heat medium.

### Seventh Embodiment

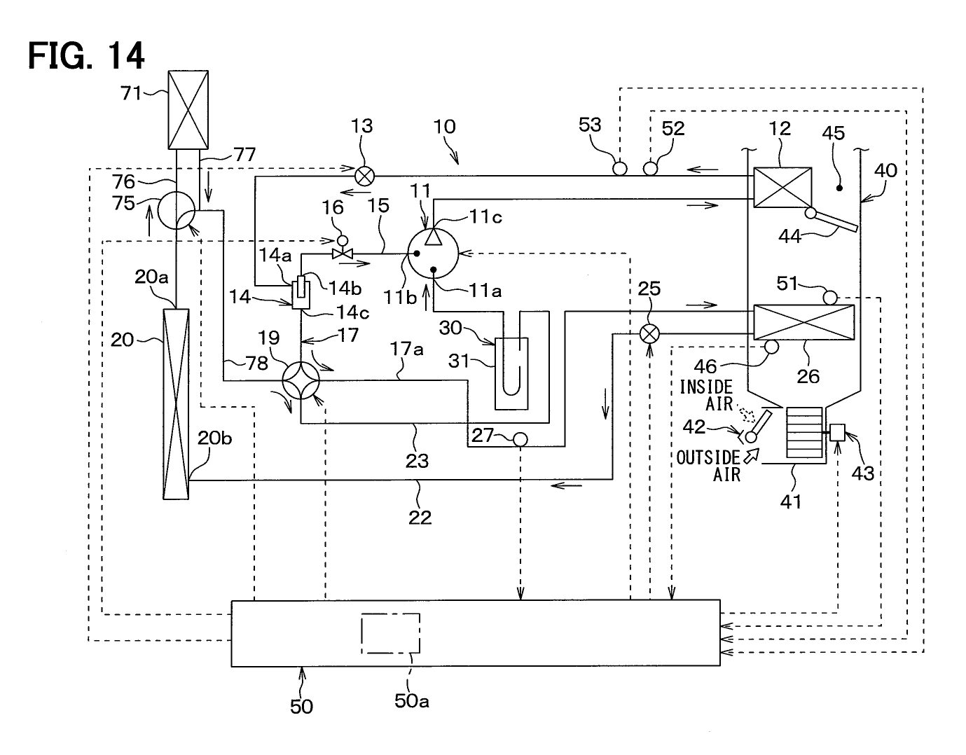

Next, a seventh embodiment will be described with reference to FIG. 14. In a heat pump cycle 10 according to the present embodiment, in the configuration of the heat pump cycle 10 according to the sixth embodiment, the three-way valve 70 and the additional passages 72, 74 are eliminated, and a three-way valve 75 and additional passages 76, 77 are added. In the present embodiment, the portion of the low-pressure refrigerant passage 22 on the side of the exterior heat exchanger 20 and the portion of the second pressure reducing mechanism 25 are connected to each other in the same manner as in the first embodiment. In the present embodiment, the ventilation heat recovery heat exchanger 71 also corresponds to an exterior heat exchanger.

The three-way valve 75 is disposed in a passage (hereinafter referred to as a passage 78) between the four-way valve 19 and the refrigerant inlet and outlet 20a of the exterior heat exchanger 20 and is connected to the additional passage 76. The three-way valve 75 is configured to be switchable between a non-recovery state and a recovery state according to a control signal output from the air-conditioning control device 50. In the non-recovery state, the three-way valve 75 communicates a portion of the passage 78 on the exterior heat exchanger 20 side with a portion on the four-way valve 19 side. In the recovery state, the three-way valve 75 communicates a portion of the passage 78 on the exterior heat exchanger 20 side with the additional passage 76.

One end of the additional passage 76 is connected to the three-way valve 75, and the other end of the additional passage 76 is connected to the inlet of the ventilation heat recovery heat exchanger 71. One end of the additional passage 77 is connected to the outlet of the ventilation heat recovery heat exchanger 71, and the other end of the additional passage 77 is connected to a portion of the passage 78 on the four-way valve 19 side.

Hereinafter, the operation of the present embodiment will be described. The operation in the cooling mode and the dehumidification heating mode is the same as in the first embodiment except that the air-conditioning control device 50 switches the three-way valve 75 to the non-recovery state. Therefore, in the cooling mode and the dehumidification heating mode, no refrigerant flows through the ventilation heat recovery heat exchanger 71 and the additional passages 76, 77.

The control contents of the air-conditioning control device 50 in the heating mode are the same as that of the first embodiment except for the control contents of the three-way valve 75. In the heating mode, the air-conditioning control device 50 switches the three-way valve 75 to the recovery state.

In that case, although a flow channel in which the refrigerant that has flowed out from the exterior heat exchanger 20 reaches the four-way valve 19 is different from that in the first embodiment, the other refrigerant flow channels are the same as in the first embodiment. Specifically, in the heating mode, the refrigerant that has flowed into the exterior heat exchanger 20 exchanges the heat with the outside air and absorbs the heat. As a result, a part of the refrigerant evaporates. The refrigerant that has flowed out from the exterior heat exchanger 20 enters the additional passage 76 from the three-way valve 75 and flows into the ventilation heat recovery heat exchanger 71 through the additional passage 76. The refrigerant that has passed into the ventilation heat recovery heat exchanger 71 exchanges the heat with the inside air passing through the ventilation heat recovery heat exchanger 71, and absorbs the heat. As a result, a part of the remaining part of the refrigerant evaporates. The refrigerant that has flowed out from the ventilation heat recovery heat exchanger 71 flows into the four-way valve through the portion of the passage 78 on the four-way valve 19 side.

As described above, in the present embodiment, in the heating mode, the exterior heat exchanger 20 and the ventilation heat recovery heat exchanger 71 are connected in series with each other in the stated order along the flow of the refrigerant.

As described above, in the heating mode, the ventilation heat recovery heat exchanger 71 performs heat exchange between the inside air discharged for ventilation from the vehicle interior and the refrigerant. In other words, in the heating mode, the ventilation heat recovery heat exchanger 71 leverages the ventilation heat to heat the refrigerant. In the present embodiment, in addition to the outside air, the inside air discharged from the vehicle interior for ventilation also corresponds to a heat medium.

### Eighth Embodiment

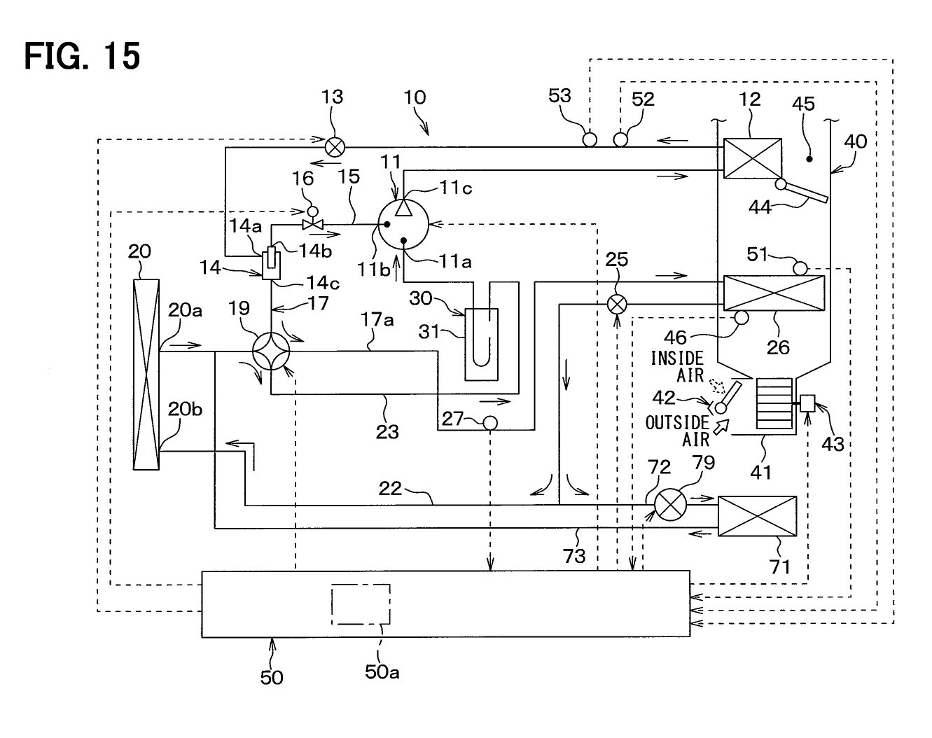

Next, an eighth embodiment will be described with reference to FIG. 15. In a heat pump cycle 10 according to the present embodiment, in the configuration of the heat pump cycle 10 according to the fifth embodiment, the three-way valve 70 is eliminated, an additional passage 72 is connected to the low-pressure refrigerant passage 22, and a flow rate control valve 79 is added in the additional passage 72. In the present embodiment, the portion of the low-pressure refrigerant passage 22 on the side of the exterior heat exchanger 20 and the portion of the second pressure reducing mechanism 25 are connected to each other in the same manner as in the first embodiment. In the present embodiment, the ventilation heat recovery heat exchanger 71 also corresponds to an exterior heat exchanger.

A flow rate control valve 79 is a motor operated valve controlled according to a control signal output from an air-conditioning control device 50, and is also an electric expansion valve. The flow rate control valve 79 is used for flow rate adjustment of the additional passage 72.

Hereinafter, the operation of the present embodiment will be described. The operation in the cooling mode and the dehumidification heating mode is the same as in the first embodiment except that the air-conditioning control device 50 controls the flow rate control valve 79 to be in a fully closed state. Therefore, in the cooling mode and the dehumidification heating mode, no refrigerant flows through the ventilation heat recovery heat exchanger 71 and the additional passage 73.

The control contents of the air-conditioning control device 50 in the heating mode are the same as in the first embodiment except that the flow rate control valve 79 is controlled to a predetermined opening degree that is not fully closed. The air-conditioning control device 50 changes the predetermined opening degree based on various conditions. For example, as the inside air temperature is higher, the predetermined opening degree may be larger. When the predetermined opening degree changes, a ratio of the flow rate of the refrigerant flowing into the ventilation heat recovery heat exchanger 71 and a flow rate of the refrigerant flowing through the exterior heat exchanger 20 changes.

In that case, although a flow channel in which the refrigerant whose pressure has been reduced by the second pressure reducing mechanism 25 reaches the four-way valve 19 is different from that in the first embodiment, the other refrigerant flow channels are the same as in the first embodiment. The refrigerant whose pressure has been reduced by the second pressure reducing mechanism 25 flows into both of the low-pressure refrigerant passage 22 and the additional passage 72. The refrigerant that has entered the additional passage 72 flows into the ventilation heat recovery heat exchanger 71 through the additional passage 72 and the flow rate control valve 79. The refrigerant that has passed into the ventilation heat recovery heat exchanger 71 exchanges the heat with the inside air passing through the ventilation heat recovery heat exchanger 71, and evaporates. The refrigerant that has flowed out from the ventilation heat recovery heat exchanger 71 flows into the accumulator 30 through the additional passage 73 and the four-way valve 19.

On the other hand, the refrigerant that has entered the low-pressure refrigerant passage 22 flows into the exterior heat exchanger 20. The refrigerant that has flowed into the exterior heat exchanger 20 exchanges the heat with the outside air, absorbs the heat, and evaporates. Also, the refrigerant that has flowed out from the exterior heat exchanger 20 flows into the accumulator 30 through the four-way valve 19.

As described above, according to the present embodiment, in the heating mode, the exterior heat exchanger 20 and the ventilation heat recovery heat exchanger 71 are connected in parallel to each other. In both of the exterior heat exchanger 20 and the ventilation heat recovery heat exchanger 71, the refrigerant is heated and evaporated.

As described above, in the heating mode, the ventilation heat recovery heat exchanger 71 performs heat exchange between the inside air discharged for ventilation from the vehicle interior and the refrigerant. In other words, in the heating mode, the ventilation heat recovery heat exchanger 71 leverages the ventilation heat to heat the refrigerant. In the present embodiment, in addition to the outside air, the inside air discharged from the vehicle interior for ventilation also corresponds to a heat medium.

### Other Embodiments

Although the embodiments have been described above, the present disclosure is not limited to the above-described embodiments, and can be appropriately modified. For example, the present disclosure can be variously modified as follows.

(1) In the embodiments described above, the heat pump cycle 10 is applied to the vehicle air conditioning apparatus. However, the application of the heat pump cycle 10 is not limited to the above configuration. For example, the heat pump cycle 10 is not limited to vehicles, and may be applied to stationary type air conditioning apparatuses, cold storage warehouse, liquid heating and cooling devices, and the like.

(2) In each of the above-described embodiments, an example in which the driving modes such as the heating mode configuring the first driving mode, the cooling mode configuring the second driving mode, and the dehumidification heating mode can be switched as the heat pump cycle 10 has been described, but the present disclosure is not limited to the above examples. The heat pump cycle 10 may be configured to be able to realize only the heating mode.

(3) In each of the embodiments described above, an example in which the compressor 11 having the low stage side compression unit and the high stage side compression unit is used has been described, but the present disclosure is not limited to the above examples. For example, as the compressor 11, a compound type compressor may be used in which a compression chamber is divided into low stage and high stage compression chambers, and a single compression unit performs two-stage pressurization.

(4) In the embodiments described above, an example in which the centrifugal separation method is employed as the gas-liquid separator 14 has been described, but the present disclosure is not limited to the above examples. As the gas-liquid separator 14, for example, a gas-liquid separator of a gravity drop type in which a gas-liquid two-phase refrigerant collides with a collision plate to decelerate the refrigerant and a high-density liquid-phase refrigerant falls downward to separate the refrigerant into gas and liquid may be employed.

(5) In each of the embodiments described above, an example in which an electric variable throttle mechanism is employed as the first to third pressure reducing mechanisms 13, 25, and 29 has been described, but the present disclosure is not limited to the above examples. As the first to third pressure reducing mechanisms 13, 25 and 29, for example, a pressure reducing mechanism in which a fixed throttle is configured by an opening and closing mechanism for opening and closing the bypass passage may be employed.

(6) In each of the embodiments described above, the temperature sensor 46 detects the temperature of the air flowing into the interior evaporator 26 (that is, the heat exchange target fluid and the counterpart fluid). However, the air-conditioning control device 50 sets the outside air temperature detected by the outside air sensor as a temperature of the air flowing into the interior evaporator 26 in the outside air mode, and sets the inside air temperature detected by the inside air sensor as a temperature of the air flowing into the interior evaporator 26 in the inside air mode.

(7) In the first to eighth embodiments, the interior condenser 12 functions as a first usage side heat exchanger. Further, in the first, second, and fourth to eighth embodiments, the interior evaporator 26 functions as a second usage side heat exchanger, and in the third embodiment, the condenser 28 functions as a second usage side heat exchanger. Therefore, in those first to eighth embodiments, the second usage side heat exchanger is disposed on the upstream side of the first usage side heat exchanger in the flow direction of the heat exchange target fluid. In the first to eighth embodiments, the heat exchange fluid and the counterpart fluid are the same blown air.

However, the present disclosure may not be always limited to the above configuration. For example, the second usage side heat exchanger may be disposed at a place that is not on the upstream side of the first usage side heat exchanger in the flow direction of the heat exchange target fluid, such as the external of the interior air conditioning unit 40. The second usage side heat exchanger may be disposed anywhere the second usage side heat exchanger and the refrigerant are cooled during the heating. In this case, the heat exchange fluid may be the blown air, and the counterpart fluid may not be the blown air in some cases.

Even with the configuration described above, the enthalpy of the refrigerant flowing into the exterior heat exchanger 20 can be reduced. Therefore, the amount of heat absorbed by the exterior heat exchanger 20 is increased, thereby being capable of increasing the amount of heat radiation of the refrigerant to the heat exchange target fluid.

(8) In the fourth embodiment described above, the engine 59 may be replaced with the traveling electric motor. In that case, the exterior heat exchanger 20 performs heat exchange between the air heated by a coolant for cooling the traveling electric motor and the refrigerant in the heating mode.

(9) In the fourth embodiment, in the heating mode, the exterior fan described above is rotated in a direction opposite to that in the cooling mode and the dehumidification heating mode. As a result, the outside air is first heated through the radiator 62 and then cooled through the exterior heat exchanger 20. However, in the heating mode, the exterior fan described above may be stopped without rotating in reverse. In that case, in the heating mode, the same advantages can be realized by operating an additional exterior fan different from the exterior fan described above.

(10) In the eighth embodiment described above, in the heating mode, if the flow rate of the refrigerant passing through the ventilation heat recovery heat exchanger 71 is fixed without being adjusted, an electromagnetic valve may be used in place of the flow rate control valve 79.

(11) The ventilation heat recovery heat exchanger 71 according to the fifth to eighth embodiments may be replaced with an exhaust heat recovery heat exchanger. In that case, the exhaust heat recovery heat exchanger corresponds to an exterior heat exchanger.

The ventilation heat recovery heat exchanger is disposed in a passage not shown for discharging an exhaust gas of the engine 59. The refrigerant flows into the exhaust heat recovery heat exchanger from an inlet of the exhaust heat recovery heat exchanger and passes through the inside of the exhaust heat recovery heat exchanger, and thereafter flows out of the exhaust heat recovery heat exchanger from an outlet of the exhaust heat recovery heat exchanger. The refrigerant passing through the inside of the exhaust heat recovery heat exchanger is heated by exchanging the heat with an exhaust gas of the engine 59 passing through the exhaust heat recovery heat exchanger.

With the configuration described above, in the heating mode, the exhaust heat recovery heat exchanger performs heat exchange between the exhaust gas of the engine 59 and the refrigerant. In other words, in the heating mode, the exhaust heat recovery heat exchanger leverages the exhaust heat to heat the refrigerant. In the example, in addition to the outside air, the exhaust gas of the engine 59 corresponds to a heat medium.

Furthermore, as a heat medium that causes the exterior heat exchanger 20 to exchange the heat with the refrigerant, not only the air described above but also liquid such as water may be used.

(12) In the above-described respective embodiments, elements configuring the embodiments are not necessarily indispensable as a matter of course, except when the elements are particularly specified as indispensable and the elements are considered as obviously indispensable in principle.

(13) In the above-described respective embodiments, when numerical values such as the number, figures, quantity, a range of configuration elements in the embodiments are described, the numerical values are not limited to a specific number, except when the elements are particularly specified as indispensable and the numerical values are obviously limited to the specific number in principle.

What is claimed is:

1. A heat pump cycle comprising:
a compressor that compresses a low-pressure refrigerant drawn through an intake port and discharges a high-pressure refrigerant through a discharge port, and includes an intermediate-pressure port through which an intermediate-pressure refrigerant in a cycle flows into the compressor to be mixed with refrigerant being in a process of being compressed;
a first usage side heat exchanger that heats a heat exchange target fluid by performing heat exchange between the high-pressure refrigerant discharged from the discharge port and the heat exchange target fluid;
a first pressure reducing unit that reduces a pressure of the high-pressure refrigerant flowing out of the first usage side heat exchanger such that the high-pressure refrigerant becomes the intermediate-pressure refrigerant;
a gas-liquid separation unit that separates the refrigerant that has passed through the first pressure reducing unit into gas and liquid, and allows a separated gas-phase refrigerant to flow out toward the intermediate-pressure port;
a second pressure reducing unit that reduces a pressure of a liquid-phase refrigerant separated by the gas-liquid separation unit such that the liquid-phase refrigerant becomes the low-pressure refrigerant;
an additional heat exchanger that performs heat exchange between the refrigerant which has passed through the second pressure reducing unit and a heat medium, and allows the refrigerant to flow out toward the intake port;
a second usage side heat exchanger that performs heat exchange between the liquid-phase refrigerant separated by the gas-liquid separation unit and a counterpart fluid, and allows the refrigerant to flow out toward the second pressure reducing unit;
a refrigerant flow channel switching unit switching a refrigerant flow channel in the cycle to a first refrigerant flow channel or a second refrigerant flow channel, the first refrigerant flow channel being a channel in which the liquid-phase refrigerant separated by the gas-liquid separation unit flows through the second usage side heat exchanger, the second pressure reducing unit, the additional heat exchanger and the compressor in this order, the second refrigerant flow channel being a channel in which the liquid-phase refrigerant separated by the gas-liquid separation unit flows through the additional heat exchanger, the second pressure reducing unit, the second usage side heat exchanger and the compressor in this order; and
a mode switching unit that controls the refrigerant flow channel switching unit to switch between a cooling mode for cooling the vehicle interior and a heating mode for heating the vehicle interior, wherein
the mode switching unit, in the heating mode, switches the refrigerant flow channel in the cycle to the first refrigerant flow channel to cause the second usage side heat exchanger to function as a radiator, and
the mode switching unit, in the cooling mode, switches the refrigerant flow channel in the cycle to the second refrigerant flow channel to cause the second usage side heat exchanger to function as a heat absorber.

2. (canceled)

3. The heat pump cycle according to claim 1, further comprising an intermediate flow channel switching unit that switches the refrigerant flow channel in the cycle to an intermediate heat exchange flow channel through which the refrigerant flows into the second usage side heat exchanger, or an intermediate bypass flow channel through which the refrigerant bypasses the second usage side heat exchanger.

4. The heat pump cycle according to claim 3, further comprising:
a flow channel control unit that controls the intermediate flow channel switching unit;
a refrigerant temperature detection unit that detects a temperature of the liquid-phase refrigerant flowing into the second usage side heat exchanger from the gas-liquid separation unit;
a fluid temperature detection unit that detects a temperature of the counterpart fluid flowing into the second usage side heat exchanger; and
a temperature determination unit that determines whether the temperature of the counterpart fluid flowing into the second usage side heat exchanger is equal to or higher than the temperature of the liquid-phase refrigerant flowing into the second usage side heat exchanger from the gas-liquid separation unit based on the temperature of the counterpart fluid detected by the fluid temperature detection unit and the temperature of the liquid-phase refrigerant detected by the refrigerant temperature detection unit, wherein
the flow channel control unit controls the intermediate flow channel switching unit to switch the refrigerant flow channel in the cycle to the intermediate heat exchange flow channel when the temperature determination unit determines that the temperature of the counterpart fluid flowing into the second usage side heat exchanger is lower than the temperature of the liquid-phase refrigerant flowing into the second usage side heat exchanger from the gas-liquid separation unit.

5. The heat pump cycle according to claim 4, wherein
the flow channel control unit controls the intermediate flow channel switching unit to switch the refrigerant flow channel in the cycle to the intermediate bypass flow channel when the temperature determination unit determines that the temperature of the counterpart fluid flowing into the second usage side heat exchanger is equal to or higher than the temperature of the liquid-phase refrigerant flowing into the second usage side heat exchanger from the gas-liquid separation unit.

6. (canceled)
